(19) United States
(12) Patent Application Publication
(10) Pub. No.: US 2025/0121425 A1
(43) Pub. Date: Apr. 17, 2025

(54) TUBE EXPANSION TOOL

(71) Applicant: Makita Corporation, Anjo-shi (JP)

(72) Inventors: Koichi YAKABE, Anjo-shi (JP); Hiroki Ikuta, Anjo-shi (JP)

(73) Assignee: MAKITA CORPORATION, Anjo-shi (JP)

(21) Appl. No.: 18/884,905

(22) Filed: Sep. 13, 2024

(30) Foreign Application Priority Data
Oct. 17, 2023 (JP) 2023-178927

(51) Int. Cl. B21D 41/02; B25F 5/00; B25F 5/02

(52) U.S. Cl. CPC B21D 41/028; B25F 5/001; B25F 5/02

(57) ABSTRACT

A tube expansion tool for expanding a tube end portion includes a moving mechanism that moves a wedge in a front-rear direction, a plurality of jaws that mutually open radially outward when pushed by the wedge moving forward, a controller and a switch that transmits an on-signal to the controller when the switch is in an on-position. The tube expansion tool is configured such that when the controller receives the on-signal from the switch, the controller activates the moving mechanism to move the wedge (i) forward to a first advance position to open the plurality of jaws at a first opening angle, (ii) rearward to close the plurality of jaws, (iii) forward to a second advance position ahead of the first advance position to open the plurality of jaws at a second opening angle, and (iv) rearward to close the plurality of jaws.

### CROSS-REFERENCE TO RELATED APPLICATION

This application claims priority to Japanese patent application serial number 2023-178927, filed on Oct. 17, 2023, the contents of which are incorporated herein by reference in their entirety for all purposes.

### TECHNICAL FIELD

The present invention generally relates to a tube expansion tool that expands an end portion of a fluid pipe in order for the fluid pipe to be coupled to a pipe fitting.

### BACKGROUND

For example, a tube expansion tool for expanding an end portion of a copper-made fluid pipe (copper tube) is conventionally used in order to couple the end portion of the copper tube to another copper tube, in order to flow a fluid through both of the copper tube. The another copper tube that is not expanded is inserted and brazed to the expanded end portion of the copper tube, thereby mutually connecting both copper tubes. In a conventional tube expansion tool, an end portion of a copper tube is expanded by hand. In more detail, a plurality of jaws of the tube expansion tool is inserted to an end portion of the copper tube. An approximately conical wedge (mandrel) arranged radially inward of the plurality of jaws is manually operated to advance (move forward). The plurality of jaws radially outward of the wedge is pushed by the wedge, which causes the plurality of jaws to open outward. In this manner, the end portion of the copper tube into which the plurality of jaws are inserted is expanded. In a case where a thickness of the copper tube is large, a strong force may be needed to expand an end portion of the copper tube.

Instead of a manually-operated tube expansion tool, for example, a tube expansion tool that opens the plurality of jaws can be driven by an electric motor. For example, a tube expansion tool that expands a PEX tubing made of PEX (cross-linked polyethylene) is driven by an electric motor is known. This kind of an electrical tube expansion tool for expanding a PEX tubing can be utilized for a copper tube. The wedge advances (moves forward) to open the plurality of jaws by an electric motor, thereby easily expanding an end portion of the copper tube.

When an end portion of an elastically-deformed PEX tubing is expanded, the plurality of jaws are repeatedly opened/closed to gradually expand the end portion of the PEX tubing. In more detail, in an initial stage of the expansion operation, only a part of the tip ends of the plurality of jaws are inserted to the PEX tubing. An insertion length of the plurality of jaws into the PEX tubing becomes longer as the end portion of the PEX tubing is expanded. The plurality of jaws, for example, are circumferentially rotated at a specified angle (for example, 15 degrees) each time the plurality of jaws are closed.

In contrast to the PEX tubing, a copper tube is plastically deformed. Accordingly, the copper tube may be expanded at one time by a large force. Because of this, before the copper tube is expanded, approximately root portions of the plurality of jaws are inserted to the copper tube so as to expand it at one time. When the plurality of jaws are started to open, each of the plurality of jaws may not receive a load from the copper tube. Accordingly, the motor may rotate at high speed and thus a wedge inertial force for pushing the plurality of jaws may be large. Because of this, when the plurality of jaws are started to open, the end portion of the copper tube may be expanded with a maximum force by the plurality of jaws. The end portion of the copper tube may be expanded at one time by utilizing a momentum when the maximum force is applied to the end portion of the copper tube.

The plurality of jaws include, for example, six jaws. When the end portion of the copper tube is expanded at one time, each of the plurality of jaws expands radially outward. Accordingly, a force in an expansion direction may not be applied to some areas of the end portion of the copper tube between the plurality of jaws. In other words, the end portion of the copper tube includes portions which are expanded and which are not expanded. Thus, the end portion of the copper may not be uniformly expanded in its radial direction, which sometimes causes the end portion of the copper tube to be cracked. Accordingly, improved operations of the wedge and the plurality of jaws may be required in a tube expansion tool for expanding the copper tubes.

Thus, there is a need for a tube expansion tool to expand an end portion of the tube without occurring a crack or the like.

### SUMMARY OF THE DISCLOSURES

According to one aspect of the present disclosure, a tube expansion tool for expanding an end portion of a tube includes a moving mechanism that moves a wedge in a front-rear direction. The tube expansion tool also includes a plurality of jaws that mutually open radially outward when pushed by the wedge moving forward. The tube expansion tool includes a controller and a switch that transmits an on-signal to the controller when the switch is in an on-position and stops transmitting the on-signal when the switch is in an off-position. When the controller receives the on-signal from the switch, the controller activates the moving mechanism to move the wedge forward to a first advance position to open the plurality of jaws at a first opening angle. The moving mechanism then moves the wedge rearward to close the plurality of jaws and forward to a second advance position, which is ahead of (and/or in front of) the first advance position, to open the plurality of jaws at a second opening angle, which is larger than the first opening angle. Finally, the moving mechanism moves the wedge rearward to close the plurality of jaws.

Because of this configuration, when the switch is turned on, the wedge moves to the first advance position in the forward direction at first. The plurality of jaws expand the end portion of the tube to the first opening angle. Next, the wedge moves in a reverse direction to close the plurality of jaws. Then, the wedge moves to the second advance position in the forward direction. The plurality of jaws expand the end portion of the tube to the second opening angle which is larger than the first opening angle. In this manner, an opening angle of the plurality of jaws 3 can be changed by varying an advance position of the wedge. Accordingly, the end portion of the tube can be gradually expanded. By gradually expanding the end portion of the tube, the end portion of the tube can be prevented from being damaged or cracked while it is expanded to have a target diameter.

### BRIEF DESCRIPTION OF DRAWINGS

FIG. 1 is a perspective view of a tube expansion tool according to an exemplary embodiment of the present disclosure, showing a plurality of jaws are closed.

FIG. 2 is a perspective view of the tube expansion tool, showing the plurality of jaws opens at a maximum opening angle.

FIG. 3 is a right side view of the tube expansion tool, showing that the plurality of jaws opens at the maximum opening angle.

FIG. 4 is an exploded perspective view of a tool main body of the tube expansion tool.

FIG. 5 is a perspective view of the tool main body when viewed from the rear right thereof, showing an outer case is removed from the tool main body.

FIG. 6 is a perspective view of the tool main body when viewed from the rear left thereof, showing the outer case is removed from the tool main body and a screw shaft is at an initial position.

FIG. 7 is a left side view of the tool main body, showing the outer case is removed from the tool main body and the screw shaft is at the initial position.

FIG. 8 is a left side view of the tool main body, showing the outer case is removed from the tool main body and the screw shaft is at an end position.

FIG. 9 is a longitudinal cross-sectional view of the tool main body when viewed from the right thereof, showing a wedge and the screw shaft are at the initial position.

FIG. 10 is a longitudinal cross-sectional view of the tool main body when viewed from the right thereof, showing the wedge and the screw are at the end position.

FIG. 11 is a cross-sectional view taken along line XI-XI of FIG. 9.

FIG. 12 is a cross-sectional view taken along line XII-XII of FIG. 11.

FIG. 13 is a view similar to FIG. 12, showing the wedge and the screw shaft are at the end position.

FIG. 14 is a top view of a rotation gear, a cam member and the plurality of jaws.

FIG. 15 is a block diagram, showing electrical components in the tube expansion tool.

FIG. 16 is a flow chart of a first embodiment, showing the movements of the wedge and the plurality of jaws.

FIG. 17 is a flow chart of a second embodiment, showing the movements of the wedge and the plurality of jaws.

FIG. 18 is a flow chart of a third embodiment, showing the movements of the wedge and the plurality of jaws.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to one aspect of the present disclosure, the tube expansion tool includes a rotation mechanism to rotate the plurality of jaws around an axis of the wedge in interlocking with a rearward movement of the wedge. Because of this configuration, a position of each of the plurality of jaws is varied around the axis of the wedge each time the plurality of jaws close. Accordingly, each of the plurality of jaws that contacts the inner circumferential surface of the end portion of the tube is varied around the axis of the wedge. Thus, an opening shape of the end portion of the tube can be an approximately circular by performing this expansion operation several times. Accordingly, the end portion of the tube can be expanded in an equal manner, thereby preventing the end portion of the tube from being damaged or cracked.

According to another aspect of the present disclosure, the controller activates the moving mechanism to move the wedge forward from a initial position to the first advance position. The moving mechanism moves the wedge rearward from the first advance position to the initial position to close the plurality of jaws. The controller activates the moving mechanism to move the wedge forward from the initial position to the second advance position and rearward from the second advance position to the initial position. Because of this configuration, the plurality of jaws completely close to the closed position each time the wedge moves to the initial position in the reverse direction. Accordingly, when the plurality of jaws close while rotating around the axis of the wedge, the plurality of jaws is prevented from contacting the end portion of the tube. Thus, the plurality of jaws can be prevented from clinging to the end portion of the tube, thereby smoothly opening and closing the plurality of jaws.

According to another aspect of the present disclosure, the controller activates the moving mechanism to move the wedge forward from the initial position to the second advance position. The moving mechanism moves the wedge rearward from the second advance position to a first retreat position in front of the initial position. The controller activates the moving mechanism to move the wedge from the first retreat position to a position ahead of (and/or in front of) the second advance position. By positioning the first retreat position in front of the initial position, a total moving distance of the wedge can be decreased. Accordingly, the end portion of the tube can be quickly expanded.

According to another aspect of the present disclosure, while the controller receives the on-signal from the switch, the controller activates the moving mechanism to move the wedge several times in the front-rear direction and brings the wedge close to an end position each time the wedge moves forward. When the wedge reaches the end position, the controller activates the moving mechanism to move (return) the wedge to the initial position to stop moving the wedge 3. Because of this configuration, when the wedge reaches the end position, the plurality of jaws expand the end portion of the tube to the maximum opening angle. After an expansion operation of the end portion of the tube is completed, the wedge moves (returns) to the initial position and stops, thereby quickly transferring to a preparation of a next expansion operation for another tube. Accordingly, an operation time of expanding the end portion of each of several tubes can be shortened, thereby improving a workability of tube expansion work.

According to another aspect of the present disclosure, while the controller receives the on-signal from the switch, the controller activates the moving mechanism to move the wedge several times in the front-rear direction and brings the wedge close to the end position each time the wedge moves forward. When the wedge reaches the end position, the controller moves the wedge rearward and forward to the end position again. Because of this configuration, when the wedge reaches the end position, the plurality of jaws expand the end portion of the tube to the maximum opening angle. By repeating the operation of opening the plurality of jaws to the maximum opening angle and closing the plurality of jaws, an opening shape of the end portion of the tube can be approximately circular.

According to another aspect of the present disclosure, the tube expansion tool includes an input part to put a number of times the wedge moves in the front-rear direction. The input part is configured to transmit an information relating to the number of times to the controller. Accordingly, the number of times the wedge moves in the front-rear direction can be changed according to a diameter, a thickness and a kind of material of the tube. Thus, the end portion of the tube can be efficiently prevented from being damaged or cracked.

According to another aspect of the present disclosure, the controller determines the first advance position and the second advance position based on the information relating to the number of times that is input to the input part. Because of this configuration, the controller efficiently moves the wedge by determining the first advance position and the second advance position, thereby improving a workability of the tube expansion work.

According to another aspect of the present disclosure, the tube expansion tool includes an initial position sensor that detects an initial position of the wedge and transmits a signal to the controller. Also, the tube expansion tool includes an end position sensor that detects an end position of the wedge and transmits a signal to the controller. The tube expansion tool includes a motor that drives the moving mechanism. The tube expansion tool includes a rotation number detection sensor that detects a rotation number of the motor and transmits a signal to the controller. The controller determines a position of the wedge based on the signal from the rotation number detection sensor. Because of this configuration, by detecting the rotation number of the motor, the controller can quickly determine the position of the wedge with respect to the initial position and the end position. Accordingly, the wedge can be moved and the plurality of jaws can be opened/closed in a smooth manner.

According to another aspect of the present disclosure, the moving mechanism includes a screw shaft attached to the wedge, and also includes a female screw member that engages the screw shaft and rotates around an axis of the screw shaft to move the screw shaft in the front-rear direction. Because of this configuration, in the tube expansion tool, where rotation of the female screw member is converted into the movement of the wedge in the front-rear direction, the wedge can be moved to several advance positions to open the plurality of jaws at several opening angles. Thus, the end portion of the tube can be expanded while it can be prevented from being damaged or cracked.

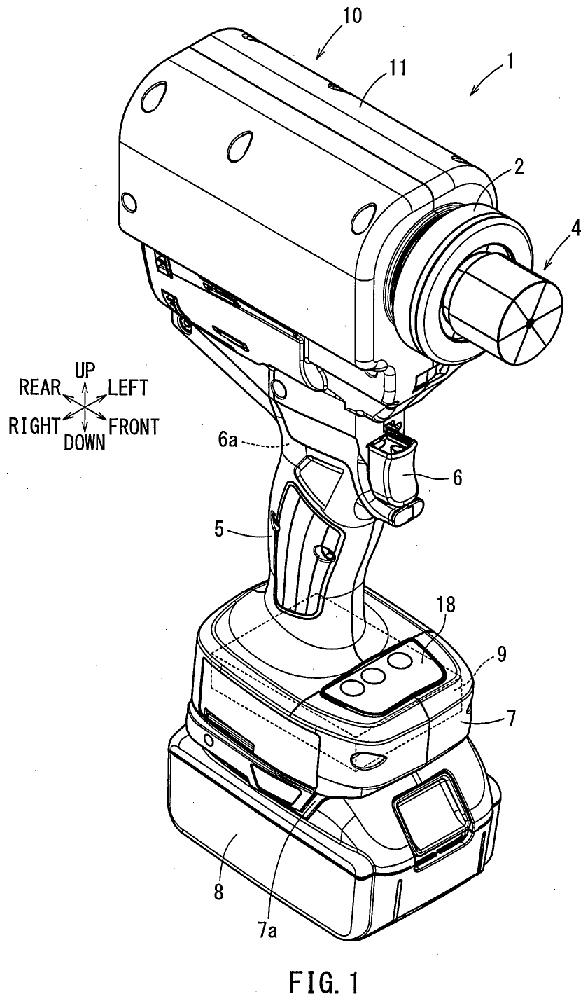

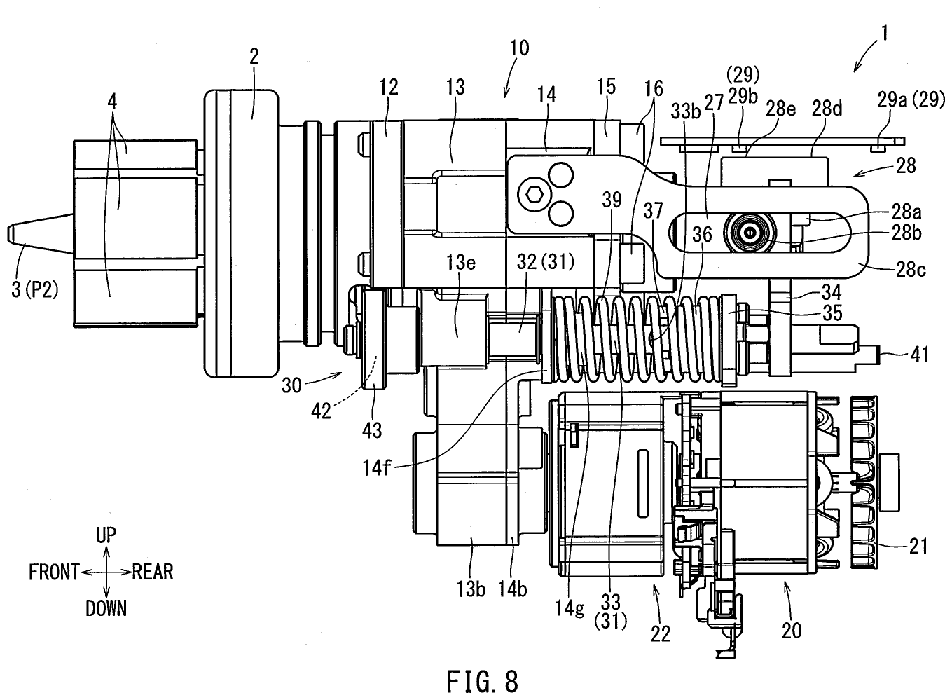

An embodiment according to the present disclosure will be explained with reference to FIGS. 1 to 18. As shown in FIG. 1, a tube expansion tool 1 of the present embodiment includes a tool main body 10 that is housed in a main body housing 11. Also, the tube expansion tool 1 includes a grip 5 in a lower portion of the main body housing. The grip 5 extends downward. In FIG. 1, a user who holds the grip 5 of the tube expansion tool 1 is situated on a rear side of the tube expansion tool 1. In the following explanation, the rear side of the tube expansion tool 1 is also referred to as a user side, and a side opposite to the user side is referred to as a front side. A left/right side and an upper/lower side is based on a user's position.

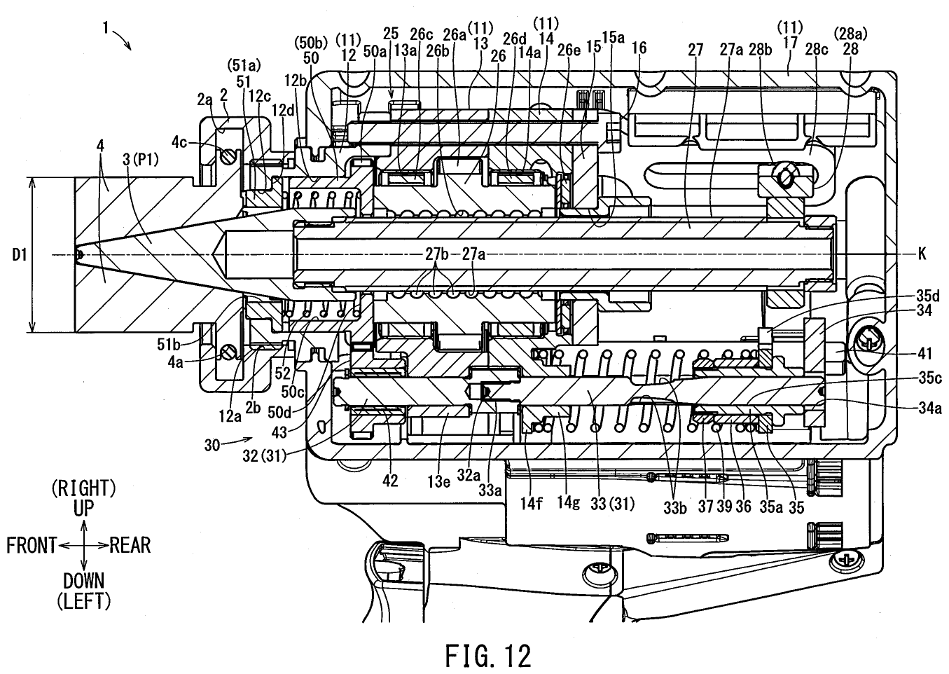

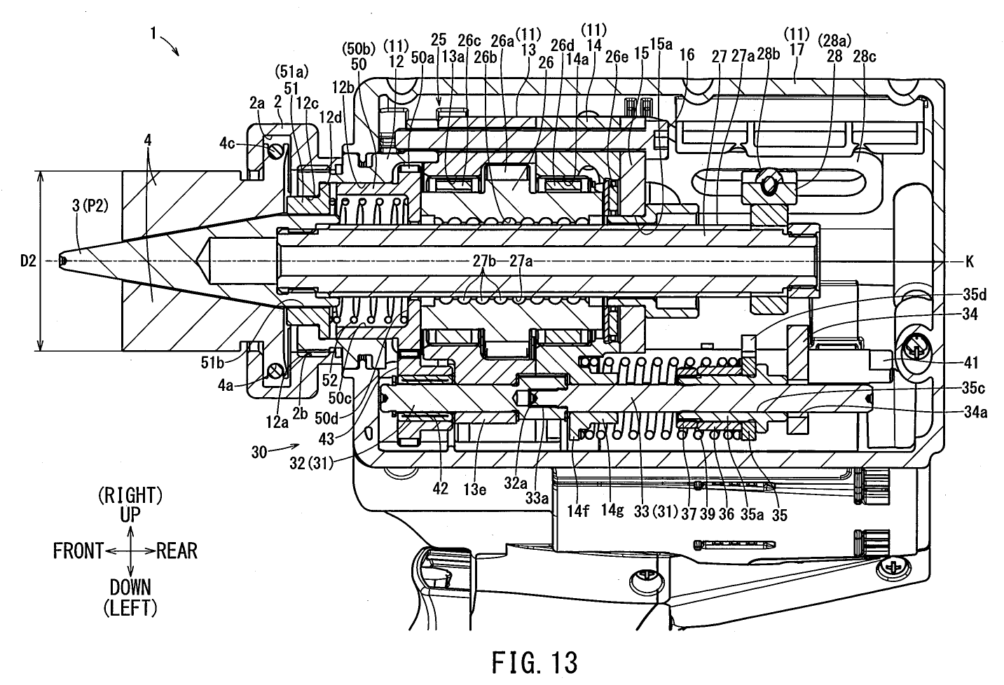

As shown in FIGS. 1, 9 and 10, a ring-shaped cap 2 attaches to a front portion of the tool main body 10. A cylindrical-shaped screw shaft 27 extending in a front-rear direction is arranged in the middle of the tool main body 10. An approximately conical wedge 3 attaches to a front portion of the screw shaft 27. The wedge 3 is positioned radially inside of the cap 2. The screw shaft 27 and the wedge 3 are arranged along a screw shaft axis line K that extends in the front-rear direction in the middle of the tool main body 10. The screw shaft 27 and the wedge 3 are movable along the screw shaft axis line K in the front-rear direction. As shown in FIGS. 12 and 13, the wedge 3 is movable in the front-rear direction between an initial position P1 (rear-end position) and an end position P2 (front-end position).

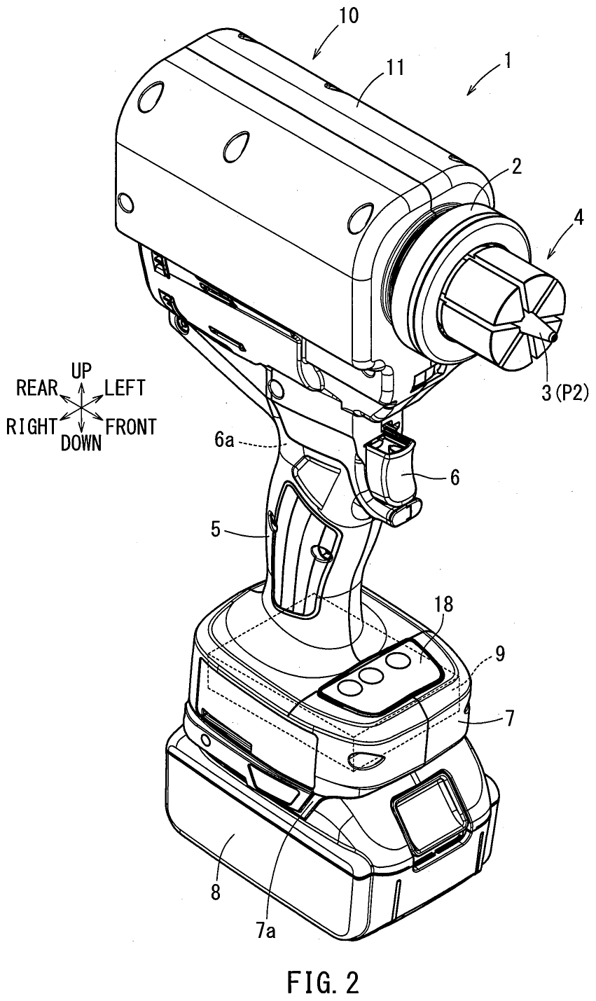

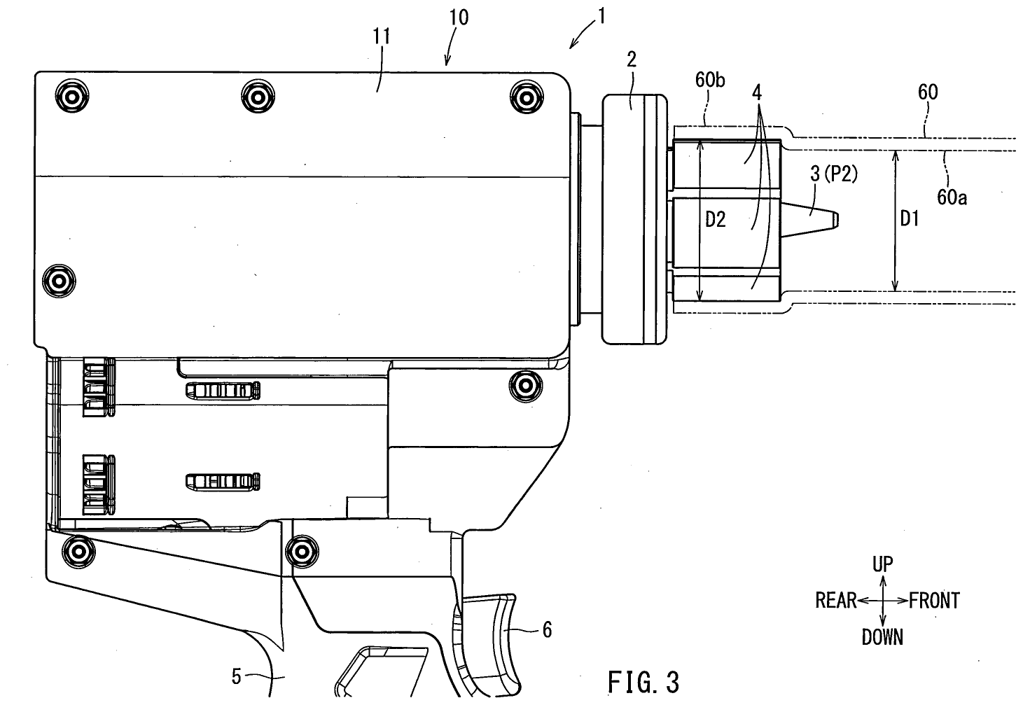

As shown in FIGS. 2, 3, 9 and 10, a plurality of jaws 4 are arranged extending in the front-rear direction. The plurality of jaws 4 are radially outward of the wedge 3 and radially inward of the cap 2. The plurality of jaws 4 are arranged in a circumferential direction of the wedge 3 at equal intervals. The tube expansion tool 1 includes, for example, six jaws 4. The six jaws 4 are arranged in the circumferential direction of the wedge 3 at an equal interval of 60 degrees. As shown in FIG. 3, the plurality of jaws 4 are inserted to an end portion 60b of a cylindrical-shaped tube 60. The tube 60, which is, for example, made of copper, is formed to have an approximately specific diameter and thickness in its longitudinal direction. The plurality of jaws 4 are opened/closed in a radial direction between a closed position and a maximum opening position. In the closed position, the plurality of jaws 4 contact with each other in the circumferential direction so as to cover the wedge 3. In the maximum opening position, the plurality of jaws 4 are opened radially outward relative to each other so as to expose a tip portion of the wedge 3. As shown in FIG. 3, the plurality of jaws 4 have a diameter of D1 when closed (closed diameter D1). In other words, an outer circumferential surface of the plurality of jaws 4, when closed, forms a cylindrical shape. The diameter D1 is slightly smaller than a diameter of an inner circumferential surface 60a of the tube 60 that is not expanded. In the maximum opening position, the plurality of the plurality of jaws 4 have a maximum diameter of D2, forming an approximately a cylindrical shape. In the closed position and the maximum opening position, an outer circumferential surface of each of the plurality of jaws 4 extend substantially straight in the front-rear direction without not being tilted.

As shown in FIG. 3, the maximum diameter D2 is a diameter of an inner circumferential surface 60a of the tube 60 when the end portion 60b of the tube 60 is expanded. For example, the maximum diameter D2 is slighter larger than an external diameter of an end portion 60b of another tube 60 that is to be connected to the tube 60a. The end portion 60b of another tube 60 is inserted and brazed to the end portion 60b of the expanded tube 60. In this manner, the end portions 60b of the two tubes 60 are connected to each other.

As shown in FIGS. 1 and 2, a trigger-type trigger 6 is arranged at a front surface of the grip 5. A user can pull the trigger 6 while holding the grip 5. A switch 6a, which turns on and off the tool 1 in conjunction with the pull operation of the trigger 6, is disposed within the grip 5. The switch 6a is in an off-state when the trigger 6 is not pulled and in an on-state when the trigger is pulled. When the switch 6a is turned on, the switch 6a transmits an on-signal to a controller 9. When the switch 6a is turned off, the switch 6a stops transmitting the on-signal to the controller 9. When the user uses the tube expansion tool 1, the user holds the grip 5 to insert the plurality of jaws 6 to the end portion 60b of the tube 60 (refer to FIG. 3). The plurality of jaws 4 expand in the radial direction by pulling the trigger 6. Finally, the inner circumferential surface 60a of the end portion 60b of the tube 60 is expanded to the maximum diameter D2.

As shown in FIGS. 1, 2 and 11, an approximately rectangular-shaped housing 7 extending in a front-rear direction and in a left-right direction with respect to the grip 6 is disposed at a lower end of the grip 5. The housing 7 houses the controller 9. The controller 9 includes a shallow rectangular box-shaped case and a resin-encapsulated control board housed in the case. The controller 9 is housed in the housing 7 such that a width thereof (the shortest side of the case) extends in the up-down direction. The controller 9 mainly controls driving of an electric motor 20. An input part 18 is disposed on an upper surface of the housing 7. The input part 18 includes an operation portion that is, for example, pull-operable, and also includes a display portion on which an updated information is displayed by operating the operation portion. A signal input by the input part 18 is transmitted to the controller 9.

As shown in FIGS. 1, 2 and 11, a battery attachment portion 7a is provided at a lower surface of the housing 7. A rectangular box-shaped battery 8 is removably attached to the battery attachment portion 7a. The battery 8 can be removed from the battery attachment portion 7a by sliding the battery 8 in a forward direction with respect to the battery attachment portion 7a. In contrast, the battery 8 can be attached to the battery attachment portion 7a by sliding the battery 8 in a rearward direction from the front-side of the battery attachment portion 7a. The battery 8 removed from the battery attachment portion 7a can be repeatedly recharged for use for a dedicated charger. The battery 8 can be used for other electric tools. The battery 8 serves as a power source for the electric motor 20.

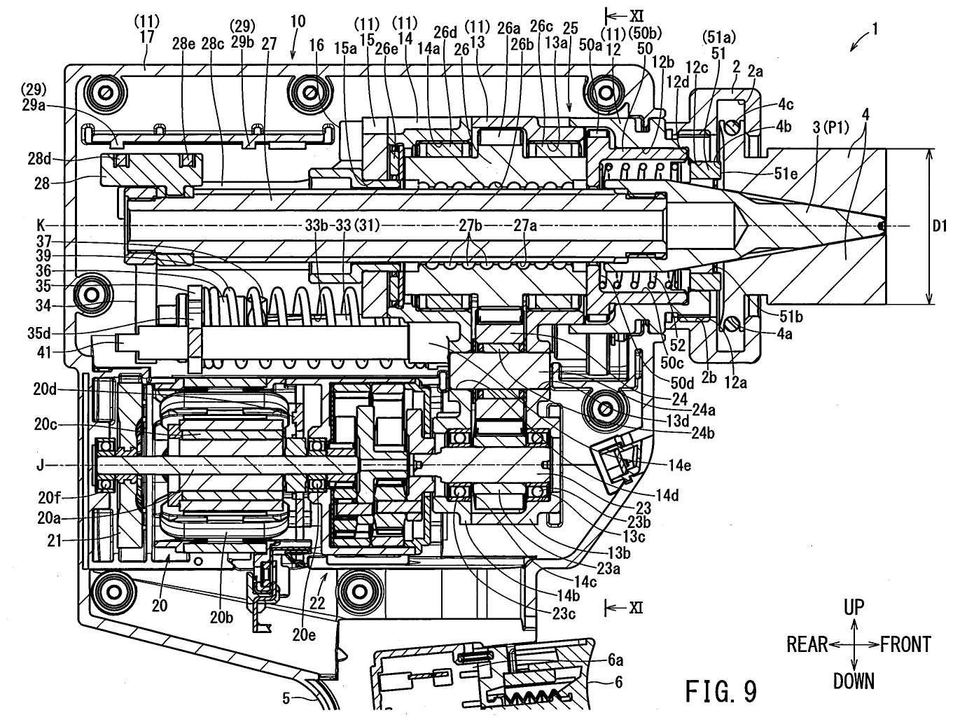

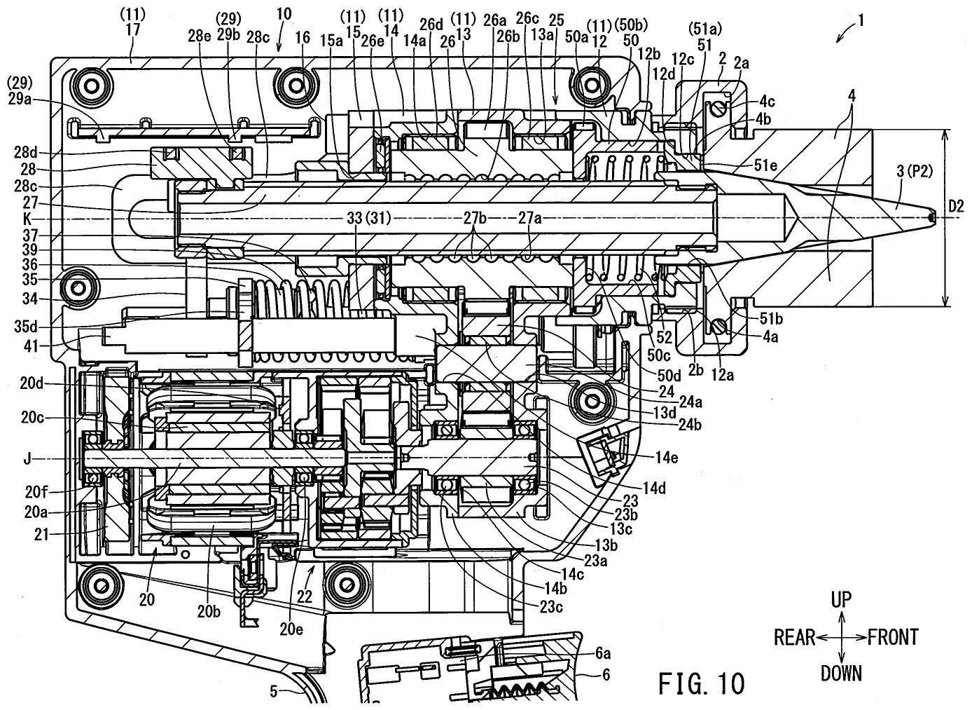

As shown in FIGS. 9 and 10, a main body housing 11 includes an outer case 17 that covers an outer periphery of the tool main body 10. The main body housing 11 also includes a front side mechanism housing 12, a first center mechanism housing 13, a second center mechanism housing 14 and a rear side mechanism housing 15, all of which are assembled in the outer case 17. The front side mechanism housing 12, the first center mechanism housing 13, the second center mechanism housing 14 and the rear side mechanism housing 15 are arranged in this order in the front-rear direction. The front side mechanism housing 12, the first center mechanism housing 13, the second center mechanism housing 14 are respectively formed to have substantially a cylindrical shape having a hollow path at the center thereof that penetrates in the front-rear direction. The rear side mechanism housing 15 is formed to have a plate having a hollow path in the same manner as the other housings. A thickness direction of the rear side mechanism housing 15 is aligned in the front-rear direction. The front side housing 12, the first center mechanism housing 13, the second center mechanism housing 14 and the rear side mechanism housing 15 are connected by the bolts 16 in the front-rear direction, cooperating to form a mechanism housing. The mechanism housing houses a gear shaft 23, an idle gear 24 and a female screw member 26, all of which will be discussed later in detail.

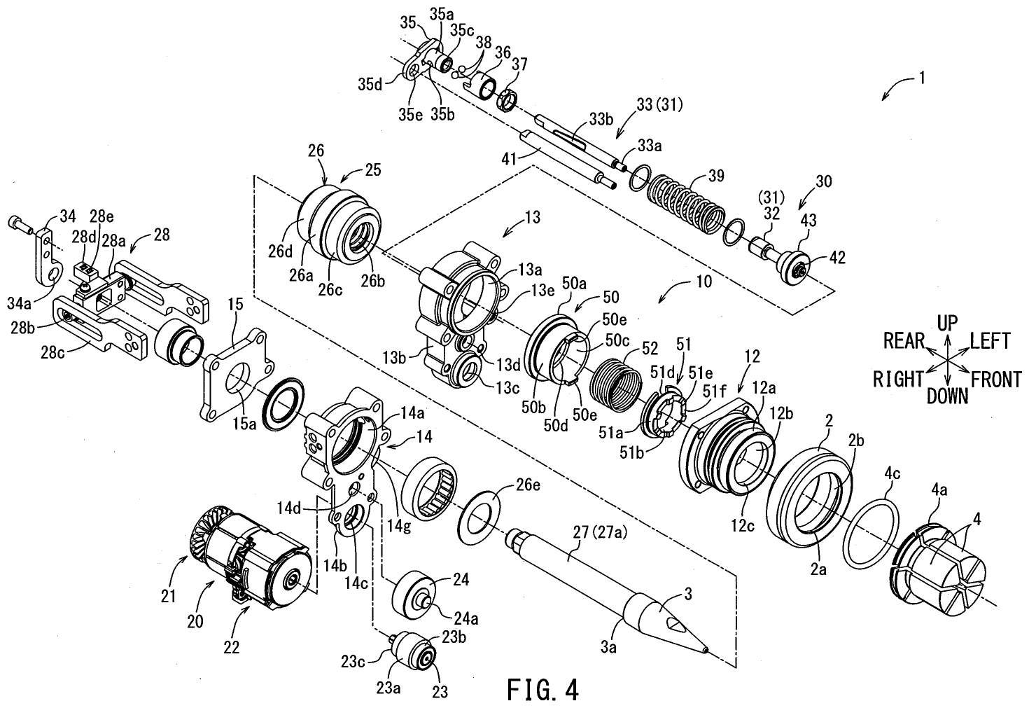

As shown in FIGS. 4, 9 and 10, a male screw 12a is formed on a front outer circumferential surface of the front side mechanism housing 12. A female screw 2b that engages the male screw 12a is formed on an inner circumferential surface of the cap 2. By engaging the male screw 12a with the female screw 2b, the cap 2 is coupled to a front portion of the front side mechanism housing 12.

As shown in FIGS. 4, 9 and 10, the first center mechanism housing 13 includes a tubular downward extension portion 13b that extends in a downward direction. The downward extension portion 13b forms an approximate U shape. Similarly, the second mechanism housing 14 includes a tubular downward extension portion 14b that extends in the downward direction and forms an approximate U shape. The downward extension portion 13b is linked to the downward extension portion 14b, thereby forming a space in which a gear shaft 23 and an idle gear 24 are housed. The downward extension portion 13b includes two through-holes that penetrate in the front-rear direction and are vertically arranged in parallel. The lower through-hole includes a recessed portion 13c for press-fitting a bearing 23b that supports a gear shaft 23. A shaft member 24a that supports the idle gear 24 is press-fit to the upper through-hole 13d. The downward extension portion 14b includes two through-holes that penetrate in the front-rear direction and are vertically arranged in parallel. The lower through hole includes a recessed portion 14c for press-fitting a bearing 23c that supports the gear shaft 23. The shaft member 24a is inserted into the upper through-hole 14d.

As shown in FIGS. 9 and 10, an approximately tubular-shaped electric motor 20 is housed in a rear lower portion of the outer case 17. The electric motor 20 is, for example, a DC blushless motor. The electric motor 20 is positioned above the grip 5 and below a screw shaft 27. A motor shaft 20a of the electric motor 20 extends along a motor shaft axis line J in the front-rear direction, which is parallel to a screw shaft axis line K that passes through a center of the screw shaft 27. The motor shaft 20a is supported by bearings 20e, 20f attached to the outer case 17 so as to be rotatable around the motor axis line J.

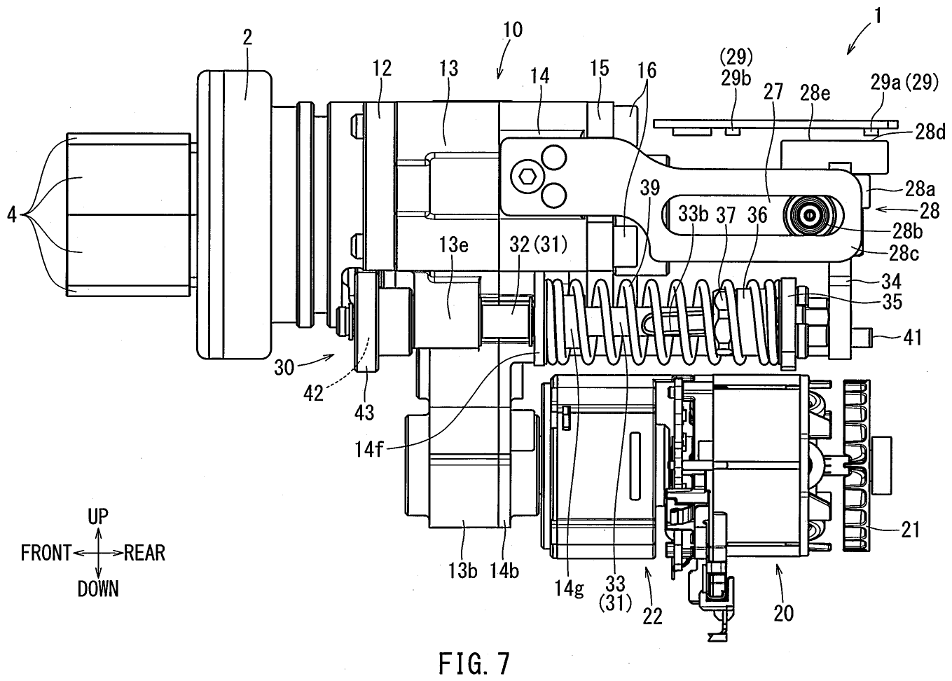

As shown in FIG. 7, the electric motor 20 includes a stator 20b that is statically supported by the outer case 17. The stator 20b is arranged radially outward of the motor shaft 20a. A rotor 20c of the electric motor 20 is attached to the motor shaft 20a on an inner circumferential side of the stator 20b so as to be integrally rotatable with the motor shaft 20a. A rotation number detection sensor 20d is disposed in front of the rotor 20c. The rotation number detection sensor 20d is used to detect the number of rotations of the motor shaft 20a by detecting, for example, a rotation angle of the rotor 21c. A fan 21 for introducing cool air to the electric motor 20 is integrally attached to the motor shaft 20a between the rotor 20c and the rear bearing 20f in the front-rear direction. When the fan 21 rotates integrally with the motor shaft 20a, cooling air flows from the front side toward the rear side of the electric motor 20.

As shown in FIGS. 9 and 10, a planetary gear reduction mechanism 22 for reducing an output speed of the motor shaft 20a is positioned in front of the electric motor 20. The planetary gear reduction mechanism 22 and the motor 20 are housed in the outer case 17 along the front-rear direction. The motor shaft 20a rotates the gear shaft 23 such that the rotation speed of the electric motor 20 is reduced at two stages by the planetary gear reduction mechanism 22. The gear shaft 23 is supported by bearings 23b, 23c so as to be rotatable around the motor axis line J. The gear shaft 23 includes a driving side gear 23a between the front bearing 23b and the rear bearing 23c. The driving side gear 23a rotates around the motor axis line J integrally with the gear shaft 23.

As shown in FIGS. 9 and 10, an idle gear 24 is positioned between the gear shaft 23 and the screw shaft 27 in the up-down direction. The idle gear 24 is supported by the shaft member 24a, which is formed in a cylindrical shape and extends in the front-rear direction, so as to be rotatable around an axis of the shaft member 24a. A radial bearing 24b is disposed radially between the idle gear 24 and the shaft member 24a. The idle gear 24 engages the driving side gear 23a of the gear shaft 23 that is positioned below the idle gear 24. The idle gear 24 also engages a driven side gear 26a of the female screw member 26 that is positioned above the idle gear 24.

As shown in FIGS. 9 and 10, the tool main body 10 includes a moving mechanism 25, which is also referred to as a ball screw mechanism. The moving mechanism 25 includes the screw shaft 27 and a female screw member 26. A male screw 27a is formed on an outer circumferential surface of the screw shaft 27. The female screw member 26 forms an approximate cylindrical shape and cover the screw shaft 27 in a circumferential direction. A female screw 26b is formed on an inner circumferential surface of the female screw member 26. The female screw 26b of the female screw member 26 engages the male screw 27a of the screw shaft 27 via a plurality of balls 27b. The driven side gear 26a, which extends radially outward and engages the idle gear 24, is formed on an outer circumferential surface of the female screw member 26. A rotation of the gear shaft 23 is transmitted to the female screw member 26 at lower speed due to the engagement of the driving side gear 23a with the idle gear 24 and the engagement of the idle gear 24 with the driven side gear 26a.

As shown in FIGS. 9 and 10, the female screw member 26 is rotatably supported around the screw shaft axis line K by bearings 26c, 26d that are housed in the tool main body 10. The front bearing 26c is press-fit to an inner circumferential surface 13a of the first center mechanism housing 13. The rear bearing 26d is press-fit to an inner circumferential surface 14a of the second center mechanism housing 14. A thrust bearing 26e for receiving a thrust load that pushes the female screw member 26 in a rearward direction is arranged between a rear surface of the female screw member 26 and a front surface of the rear side mechanism housing 15. A rear portion of the screw shaft 27 protrudes in a rearward direction from a through-hole 15b that is formed at a center of the rear side mechanism housing 15.

As shown in FIGS. 4 to 6, a screw shaft guide 28 is positioned at a rear portion of the screw shaft 27. The screw shaft guide 28 guides a movement of the screw shaft 28 in the front-rear direction. Also, the screw shaft guide 28 stops rotation of the screw shaft 28. The screw shaft guide 28 includes a roller shaft 28a that is coupled to an end portion of the screw shaft 27 and that extends in a left-right direction. A roller 28b is provided on both left and right ends of the roller shaft 28a. A pair of rails 28c that are each formed in a loop shape and extends in the front-end direction are provided on both left and right sides of the second center mechanism housing 14. The roller 28b engages the pair of the rails 28c so as to move in the front-rear direction along the pair of rails 28c. The screw shaft 27 is moved integrally with the roller shaft 28a in the front-rear direction while being guided by the roller 28b and the pair of the rail 28c.

As shown in FIGS. 7 to 10, a magnet 28d, 28e is mounted on an upper portion of the roller shaft 28a. The magnet 28d on a rear side is spaced apart from the magnet 28e on a front side in the front-rear direction. A position sensor 29 for detecting a position of the screw shaft 27 in the front-rear direction is attached to an inner circumferential surface of an upper portion of the outer case 17. The position sensor 29 detects magnetism of the magnet 28d, 28e, which is referred to as a hall element. The position sensor 29 includes an initial position sensor 29a on a rear side and an end position sensor 29b on a front side. The initial position sensor 29a is positioned such that when the wedge 3 and the screw shaft 27 is at an initial position P1, the initial position sensor 29a is above the magnet 28d. When the initial position sensor 29a is above the magnet 28d, the initial position sensor 29a detects magnetism of the magnet 28d, which means that the wedge 3 is at the initial position P1, and transmits a signal to the controller 9. The end position sensor 29b is positioned such that when the wedge 3 and the screw shaft 27 are at an end position P2, the end position sensor 29b is above the magnet 28e. When the end position sensor 29b is above the magnet 28e, the end position sensor 29b detects magnetism of the magnet 28e, which means that the wedge 3 is at the end position P2, and transmits a signal to the controller 9.

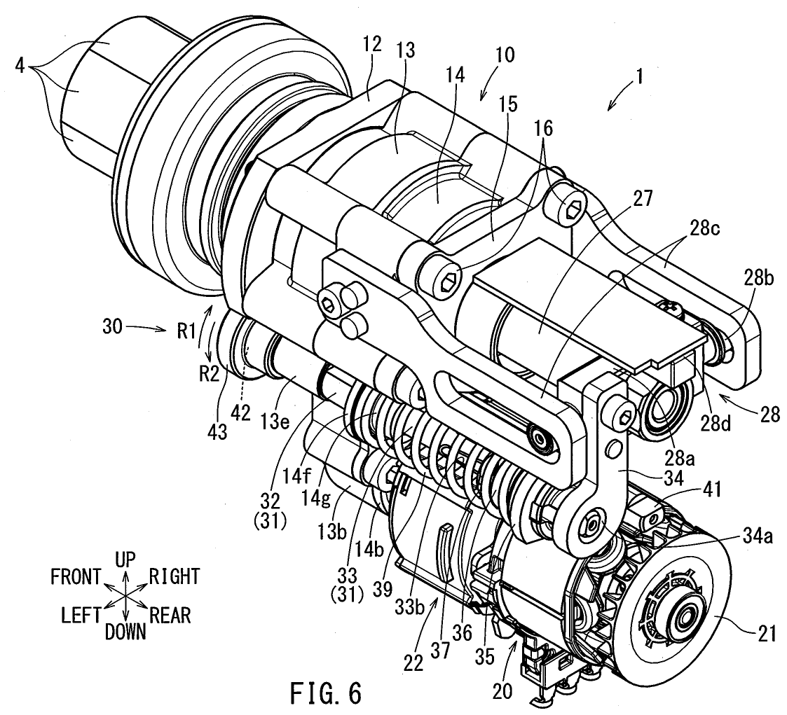

As shown in FIGS. 6-8, 12 and 13, the tool main body 10 includes a rotation mechanism 30 that rotates the plurality of jaws 4. As shown in FIGS. 12 and 13, the plurality of jaws 4 rotate around the screw shaft axis line K by the rotation mechanism 30. The rotation mechanism 30 includes a push plate 34 that moves in the front-rear direction in interlocking with rotation of the motor shaft 20a. The rotation mechanism 30 also includes a shaft 31 that rotates around an axis of the shaft 31 in interlocking with the movement of the push plate 34 in the front-rear direction.

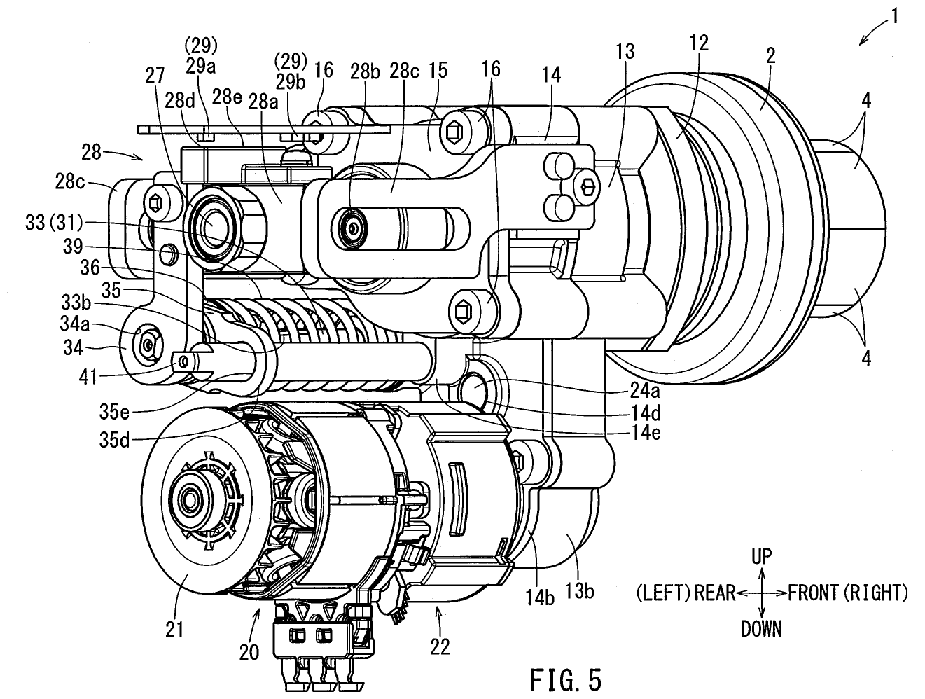

As shown in FIGS. 5, 7, and 8, the rotation mechanism 30 includes a ball retainer 35 that is attached to the shaft 31. The ball retainer 35 is movable in the front-rear direction along an extending direction of the shaft 31. A guide shaft 41 extending in parallel with the shaft 31 is positioned on the right side of the shaft 31. A tubular guide shaft support portion 14e that extends in the rearward direction is arranged in the downward extension portion 14b of the second center mechanism housing 14. A female screw is formed on a center of the guide shaft support portion 14b so as to penetrate in the front-rear direction. A male screw provided at an end portion of the guide shaft 41 engages the female screw of the guide shaft support portion 14e, thereby fixing the guide shaft 41 to the second center mechanism housing 14.

As shown in FIGS. 4 and 5, the ball retainer 35 includes an approximately cylindrical-shaped sleeve attachment portion 35a and a lateral extension portion 35d. The lateral extension portion 35d extends in a rightward direction of the sleeve attachment portion 35a. A shaft insertion hole 35c that penetrates in the front-rear direction is formed at the center of the sleeve attachment portion 35a. The shaft 31 is inserted by sliding into the shaft insertion hole 35c in the front-rear direction. A through-hole 35e that penetrates in the front-rear direction is formed in the lateral extension portion 35d. The guide shaft 41 is inserted by sliding into the through hole 35e in the front-rear direction. Because of this configuration, the ball retainer 35 can be slid in the front-rear direction while being guided by the shaft 31 and the guide shaft 41. Also, the ball retainer 35 can be prevented from rotating around the shaft 31.

As shown in FIGS. 4 to 6, the push plate 34 is formed in a plate shape. The push plate 34 is integrally attached to the roller shaft 28a such that a plate thickness direction is the front-rear direction. The push plate 34 extends downward below the roller shaft 28a. Also, the push plate 34 is arranged behind the sleeve attachment portion 35a. The push plate 34 includes a through hole 34a that penetrates in the front-rear direction. The shaft 31 extending rearward behind the sleeve attachment portion 35a passes through the through-hole 34a. The push plate 34 moves in the front-rear direction integrally with the screw shaft 27. When the screw shaft 27 moves forward, the push plate 34 presses the rear surface of the ball retainer 35 in the forward direction. When the screw shaft 27 moves rearward, the push plate 34 moves so as to be apart from the ball retainer 35. Because of this configuration, the push plate 34 applies a force only when the push plate 34 moves forwards. In other words, the push plate 24 does not produce a force to move the ball retainer 35.

As shown in FIG. 4, the sleeve attachment portion 35a includes a pair of ball retention holes 35b that penetrate in the left-rear direction and that communicate with the shaft insertion hole 35c. A ball 38 is inserted into each pair of ball retention holes 35b. The pair of balls 38 and a sleeve 36 that covers the ball retention holes 35b from radially outward are mounted to the sleeve attachment portion 35a. By mounting the sleeve 36 to the sleeve attachment portion 35a, the pair of balls 38 can be statically retained in the ball retention holes 35b. Each pair of balls 38 is disposed on the left and right side of the shaft 31. In other words, each pair of balls 38 is arranged so as be opposed by 180 degrees around the axis of the shaft 31. The pair of balls 38 can be prevented from rotating around the shaft 31 due to the static ball retainer 35. A nut 37 for retaining the sleeve 36 is attached to a front portion of the sleeve attachment portion 35a.

As shown in FIGS. 4, 12, and 13, a front shaft 32 is attached to a rear shaft 33 in the front-rear direction to form the shaft 31. The front shaft 32 is supported by a shaft supporting portion 13e of the first center mechanism housing 13 so as to be rotatable around an axis of the front shaft 32. The rear shaft 33 is supported by a shaft supporting portion 14g of the second center mechanism housing 14 so as to be rotatable around an axis of the rear shaft 33. The rear shaft 33 is inserted into the ball retainer 35. A male screw 33a is formed in a front portion of the rear shaft 33. A female screw 32a that engages the male screw 33a of the rear shaft 33 is formed in a rear portion of the front shaft 32. By screw-connecting the female screw 32a of the front shaft 32 to the male screw 33a of the rear shaft 33, the front shaft 32 is integrally connected to the rear shaft 33.

As shown in FIGS. 4, 12, and 13, a pair of ball grooves 33b are formed on an outer circumferential surface of the rear shaft 33. Each pair of ball grooves 33b extends in a longitudinal direction of the rear shaft 33. Also, each of the pair of ball grooves 33b extends on a circumferential direction from rear to front like a screw groove. Referring to FIG. 6, each of the ball grooves 33b extends from rear to front in a direction indicated by an arrow R2 (a second rotation direction). The pair of ball grooves 33b are arranged in a positional relationship of point symmetry with respect to an axis center of the rear shaft 33. Each pair of balls 38, which is disposed radially inward from the ball retention hole 35b, engages one of the corresponding ball grooves 33b.

As shown in FIGS. 6-8, when the ball retainer 35 moves in the front-rear direction with respect to the rear shaft 33, the pair of balls 38 (refer to FIG. 4) move in the ball grooves 33b along the extension direction of the ball grooves 33b. The pair of balls 38 do not rotate around the rear shaft 33, and thus the rear shaft 33 rotates around the axis of the rear shaft 33 with respect to the ball retainer 35 that moves in the front-rear direction. When the ball retainer 35 moves in the forward direction, the rear shaft 33 rotates in a direction indicated by an arrow R1 (a first rotation direction) with respect to the ball retainer 35. On the other hand, when the ball retainer 35 moves in the rearward direction, the rear shaft 33 rotates in a direction indicated by the arrow R2 (the second rotation direction) with respect to the ball retainer 35. The front shaft 32 that is screw-connected to the rear shaft 33 rotates integrally with the rear shaft 33 around an axis of the front shaft 32. A flange-shaped spring receiving portion 14f that extends radially outward is formed in the shaft supporting portion 14g of the second center mechanism housing 14. A compression spring 39 that biases the ball retainer 35 in the rearward direction is inserted between the spring receiving portion 14f and the ball retainer 35.

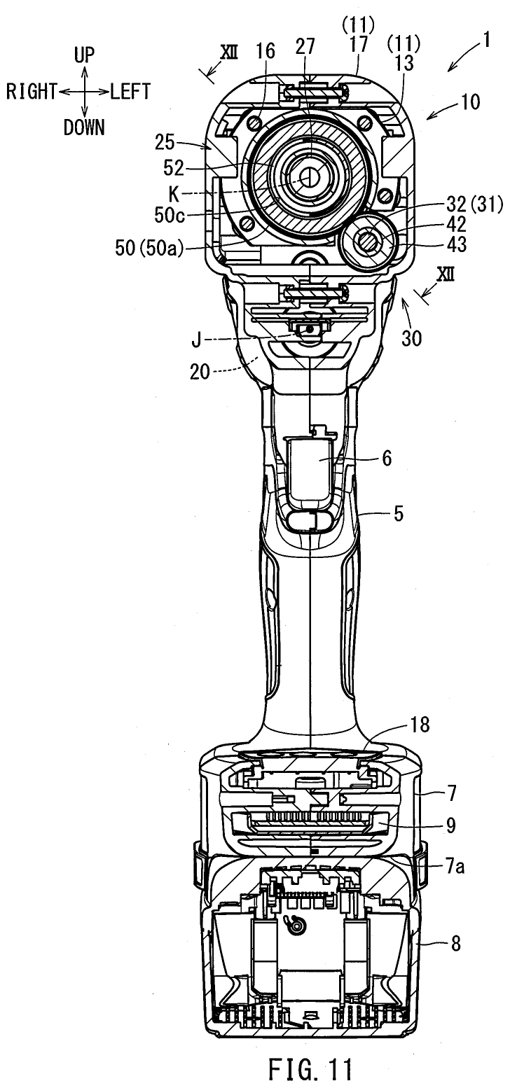

As shown in FIGS. 11-13, the rotation mechanism 30 includes a cylindrical-shaped one-way clutch 42 and a driving side gear 43. The one-way clutch 42 and the driving side gear 43 are attached to a front portion of the front shaft 32 in front of the shaft supporting portion 13e. The one-way clutch 42 is disposed between the front shaft 32 and the driving side gear 43 in a radial direction of the front shaft 32. The one-way clutch 42 permits only one-way rotation of the front shaft 32 on an inner circumferential side to an outer circumferential side in the radial direction of the front shaft 32. The one-way clutch 42 is, for example, a sprag clutch. The one-way clutch 42 transmit rotation of the front shaft 32 in the second rotation direction R2 (refer to FIG. 6) to the driving side gear 43. On the other hand, the one-way clutch 42 does not transmit rotation of the front shaft 32 in the first rotation direction R1 (refer to FIG. 6) to the driving side gear 43. Accordingly, the front gear 32 idles.

As shown in FIGS. 4, 12, and 13, the rotation mechanism 30 includes an approximately cylindrical-shaped rotation gear 50 and an approximately cylindrical-shaped cam member 51. The rotation gear 50 is positioned in front of the female screw member 26. The cam member 51 is positioned in front of the rotation gear 50. The front side mechanism housing 12 includes a first inner circumferential surface 12b and a second inner circumferential surface 12c, both of which are centered at the screw shaft axis line K. The rotation gear 50 is supported on the inner circumferential surface 12b of the front side mechanism housing 12 so as to be coaxially rotatable around the screw shaft axis line K. The cam member 51 is supported on the inner circumferential surface 12c of the front side mechanism housing 12 so as to be coaxially rotatable around the screw shaft axis line K. A front-end of the first inner circumferential surface 12b is linked to a rear-end of the second circumferential surface 12c by an extension surface 12d that extends in a radial direction.

As shown in FIGS. 4, 12, and 13, the rotation gear 50 includes a cylindrical-shaped cylindrical wall 50b and a driven side gear 50a that extends radially outward from a rear portion of the cylindrical wall 50. The cylindrical wall 50b includes a through hole 50c in the center of the cylindrical wall 50b which penetrates in the front-rear direction. The insertion hole 50c has a diameter such that the screw shaft 27 and the wedge 3 are inserted into the insertion hole 50c and movable in the front-rear direction. The driven side gear 50a engages the driving gear 43. Rotation power of the driving side gear 43 is reduced and transmitted to the driven side gear 50a. When the driving side gear 43 rotates in the second rotation direction R2 (refer to FIG. 6), the driven side gear 50a rotates counterclockwise viewed from the front. On the contrary, when the driving side gear 43 rotates in the first rotation direction R1 (refer to FIG. 5), the driven side gear 50a rotates clockwise viewed from the front. The rotation gear 50 includes a spring receiving portion 50d that extends radially inward from a rear portion of the cylindrical wall 50b. An inner circumferential surface of the spring receiving portion 50d is sized to pass through the screw shaft 27 and not to pass through a rear-end 3a of the wedge 3. A rear portion of a coil spring 52 contacts a front surface of the spring receiving portion 50d. The coil spring 52 will be discussed later.

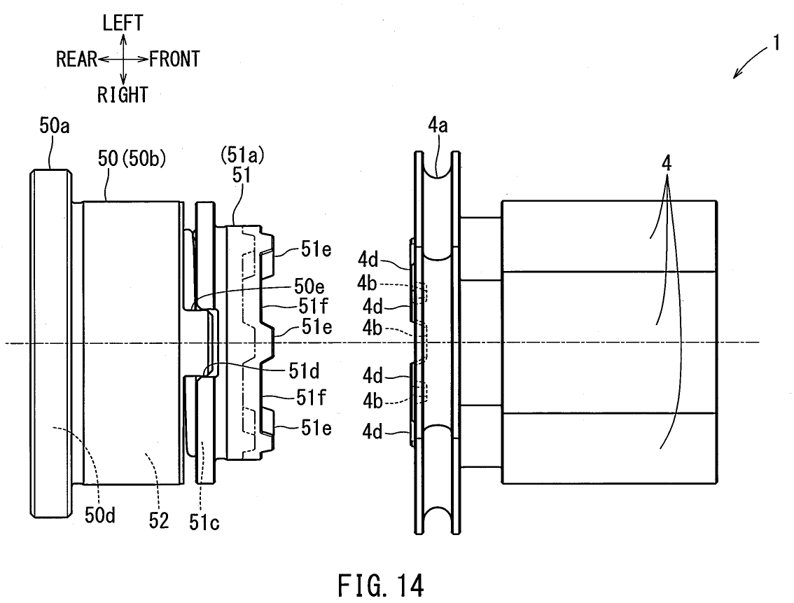

As shown in FIGS. 4 and 14, the rotation gear 50 includes an approximately rectangular-shaped guide 50e that protrudes forward from a front surface of the cylindrical wall 50b. The guide 50e is formed in a circumferential direction of the cylindrical wall 50b at an interval of 180 degrees. Thus, two guides 50e are formed in the cylindrical wall 50b. Each guide 50e guides the cam member 51 such that the cam member 51 does not rotate relatively with respect to the rotation gear 50 and is movable in the front-rear direction.

As shown in FIGS. 4, 12 to 14, the cam member 51 includes a cylindrical-shaped cylindrical portion 51a. The cylindrical portion 51a includes a through hole 51b in the center of the cylindrical portion 51a which penetrates in the front-rear direction. The through hole 51b has a diameter such that the screw shaft 27 and the wedge 3 can be inserted into the through hole 51b. The cylindrical portion 51a includes a spring receiving portion 51c that protrudes radially outward in a flange-shape at a rear portion of the cylindrical portion 51a. A coil spring (a biasing member) 52 is inserted between the spring receiving portion 50d of the rotation gear 50 and the spring receiving portion 51c of the cam member 51. The cam member 51 is biased by the coil spring 52 in the forward direction relating to the rotation gear 50.

As shown in FIGS. 4 and 14, the spring receiving portion 51c includes a guide engagement portion 51d that is cut radially inward in a cutout shape and passes through the spring receiving portion 51c in the front-rear direction. The guide engagement portion 51d is formed in a circumferential direction of the spring receiving portion 51c at an interval of 180 degrees. Each of the guide engagement portions 51d engages a corresponding guide 50e of the rotation gear 50. Because of this configuration, the cam member 51 rotates integrally with the rotation gear 50 around the screw shaft axis line K (refer to FIG. 12) by engagement of the guide engagement portions 51d with the guides 50e. Also, the cam member 51 is movable relative to the rotation gear 50 in the front-rear direction by engagement of the guide engagement portions 51d with the guides 50e.

As shown in FIGS. 4 and 14, the cam member 51 includes a plurality of cam engagement portions 51e, each of which extends forward from a front surface 51f of the cylindrical portion 51a. The cam engagement portions 51e is formed in an approximately rectangular shape. Each of the cam engagement portion 51e is formed in a circumferential direction of the cylindrical portion 51a at an interval of 60 degrees. Thus, there are six cam engagement portions 51e in total. A jaw engagement portion 4b is formed in a recessed shape on a rear surface of each of the plurality of jaws 4. Each of the plurality of jaw engagement portions 4b engages one of the plurality of cam engagement portions 51e of the cam member 51. The plurality of jaws 4 rotate integrally with the cam member 51 around the screw shaft axis line K by engagement of the cam engagement portions 51e with the jaw engagement portions 4b of the jaw 4. A plurality of projections 4d extending rearward relating to the jaw engagement portions 4b are formed at both ends of each of the jaw engagement portions 4b in a circumferential direction thereof.

As shown in FIGS. 9 and 10, each jaw 4 includes a ring housing groove 4a in an arcuate shape in cross-section on a radially outer circumferential surface of the rear portion of each jaw 4. Each ring housing groove 4a of the jaw 4 continues to each other in a circumferential direction to form an annular groove. The plurality of jaws 4 are linked to each other in the circumferential direction by a ring 4c that is elastically extensible and inserted into the ring housing grove 4a. The cap 2 includes a jaw-supporting groove 2a that houses the ring 4c in an inner circumferential surface of the cap 2. The jaw supporting groove 2a extends radially outward in a circumferential direction. The jaw supporting groove 2a allows the ring 4c to move in a radial direction and prevents the ring 4c from moving in the front-rear direction. The plurality of jaws 4 open/close radially with respect to the ring 4c that is supported by the ring housing groove 4a.

Referring to FIGS. 6 to 13, the moving mechanism 25 and the rotation mechanism 30 will be explained as follows. The controller 9 can switch between a forward rotation and a reverse rotation of the motor shaft 20a of the electric motor 20. When the motor shaft 20a of the electric motor 20 rotates, a rotation speed of the motor shaft 20a is reduced by the planetary gear reduction mechanism 22 to transmit to the gear shaft 23. When the gear shaft 23 rotates, the idle gear 24 that engages the driving side gear 23a rotates. The driven side gear 26a of the female screw member 26 engages the idle gear 24 to rotate the female screw member 26 around the screw shaft axis line K. When the female screw member 26 rotates, the screw shaft 27 that is prevented from rotation by the screw shaft guide 28 moves in the front-rear direction. The screw shaft 27 moves forward when the electric motor 20 rotates in the forward direction. On the contrary, the screw shaft 27 moves rearward when the electric motor 20 rotates in the reverse direction. When the screw shaft 27 moves forward, the wedge 3 that is attached to the end portion of the screw shaft 27 pushes both the plurality of jaws 4 and the ring 4c to open radially outward. On the contrary, when the screw shaft 27 moves rearward, the ring 4c shrinks to close the plurality of jaws 4 radially inward.

As shown in FIGS. 4 to 8, when the screw shaft 27 moves forward, the push plate 34 that is attached to the roller shaft 28a moves forward integrally with the screw shaft 27. The push plate 34 pushes the ball retainer 35 forward against a biasing force of the compression spring 39. When the ball retainer 35 moves forward, the ball 38 engages the ball groove 33b (refer to FIG. 4) and the shaft 31 rotates in the first rotation direction R1 (refer to FIG. 6) because the guide shaft 41 prevents rotation of the ball retainer 35. At this time, one-way clutch 42 does not transmit rotation power of the shaft 31 to the driving side gear 43. The rotation gear 50 does not rotate because rotation power of the shaft 31 is not transmitted to the driving side gear 43. Because of this configuration, the plurality of jaws 4 and the cam member 51 that engages the rotation gear 50 do not rotate. Accordingly, without rotating around the screw shaft axis line K, the plurality of jaws 4 are pushed by the wedge 3 to open radially outward.

When the screw shaft 27 moves rearward, the push plate 34 that is attached to the roller shaft 28a moves rearward integrally with the push plate 34. A pressing force of the push plate 34 toward the ball retainer 35 is released and the ball retainer 35 moves rearward by receiving a biasing force of the compression spring 39. When the ball retainer 35 moves rearward, the shaft 31 rotates in the second rotation direction R2 (refer to FIG. 6) because the ball 38 engages the ball groove 33b and the guide shaft 41 prevents rotation of the ball retainer 35. At this time, one-way clutch 42 transmits rotation power of the front shaft 32 to the driving side gear 43. The rotation gear 50 rotates counterclockwise viewed from the front because the rotation power of the driving side gear is transmitted to the rotation gear 50. The cam member 51 and the plurality of jaws 4 rotate integrally with the rotation gear 50. Accordingly, the plurality of jaws 4 close radially inward while rotating around the screw shaft axis line K in a counterclockwise direction viewed from the front.

Next, movements of the wedge 3 and the plurality of jaws 4 of the present disclosure will be explained. A moving position of the wedge 3, a number of times the wedge 3 moves, an opening angle of the jaws 4, a number of times the jaws 3 open/close, etc. are not limited to the following exemplified disclosures.

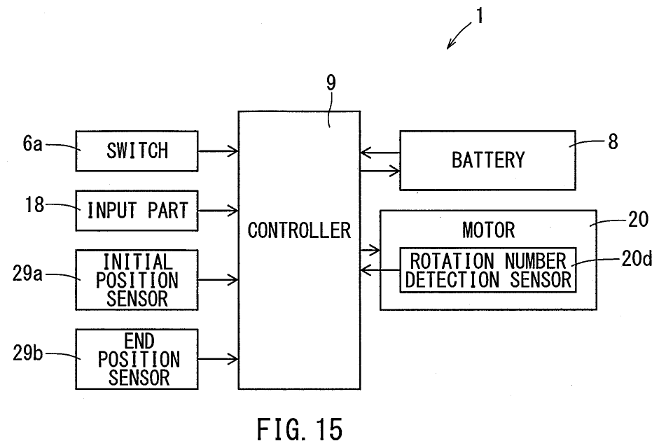

Referring to FIG. 15, the controller 9 receives an on-signal from the switch 6a to drive the motor 20. The battery 8 supplies power to the motor 20 through the controller 9 to drive the motor 20. The controller 9 determines that the wedge 3 is at the initial position P1 based on a signal transmitted from the initial position sensor 29a (refer to FIG. 9). Further, the controller 9 determines that the wedge 3 is at the end position P2 based on the end position sensor 29b (refer to FIG. 10). The controller 9 calculates a rotation number of the motor 20 to determine a moving distance of the wedge 3 from the initial position P1 or the end position P2 based on a signal transmitted from the rotation number detection sensor 20d. Thus, the controller 9 determines a position of the wedge 3 between the initial position P1 and the end position P2. The controller 9 determines a movement of the wedge 3 based on a signal transmitted from the input part 18. For example, a number of times the wedge 3 moves in the front-rear direction can be input to the input part 18, for example. A signal relating to the number of times the wedge 3 moves in the front-rear direction is transmitted to the controller 9 from the input part 18.

Referring to FIGS. 9, 10, 15 and 16, a first embodiment of movements of the wedge 3 and the plurality of jaws 4 will be explained below. A user pulls the trigger 6 at first (step 01, which hereinafter refers to as ST01). The switch 6a transmits an on-signal to the controller 9 while the trigger 6 is being pulled (ST02). The controller 9 drives the motor 20 in the forward direction (ST03). Owing to the moving mechanism 25, the wedge 3 moves by 4 mm from the initial position P1 to a first advance position behind the end position P2. The plurality of jaws 4 are pushed by the wedge 3 to open at a first opening angle, which corresponds to a diameter larger than the diameter D1 (a diameter when the plurality of jaws 4 are closed) (ST04). Next, the controller 9 drives the motor 20 in the reverse direction. The wedge 3 moves rearward by 4 mm from the first advance position to the initial position P1 owing to the moving mechanism 25. The plurality of jaws 4 close from the first opening angle to a closed position. At the same time, the plurality of jaws 4 rotate around the screw shaft axis line K owing to the rotation mechanism 30 (ST05). The plurality of jaws 4 rotate, for example, by 15 degrees counterclockwise viewed from the front.

Next, the controller 9 drives the motor 20 in the forward direction. Owing to the moving mechanism 25, the wedge 3 moves by 8 mm from the initial position P1 to a second advance position that is ahead of (and/or in front of) the first advance position and behind the end position P2. The plurality of jaws 4 are pushed by the wedge 3 to open at a second opening angle that is larger than the first opening angle (ST06). Next, the controller 9 drives the motor 20 in the reverse direction. The wedge 3 moves rearward by 8 mm from the second advance position to the initial position P1 owing to the moving mechanism 25. The plurality of jaws 4 close from the second opening angle to the closed position. At the same time, the plurality of jaws 4 rotate around the screw shaft axis line K owing to the rotation mechanism 30 (ST07). The plurality of jaws 4 rotate, for example, by 30 degrees counterclockwise viewed from the front. An angle by which the plurality of jaws 4 rotate when the wedge 3 moves rearward at one time is approximately directly proportional to a distance by which the wedge 3 moves rearward.

Next, the controller 9 drives the motor 20 in the forward direction. Owing to the moving mechanism 25, the wedge 3 moves by 12 mm from the initial position P1 to the end position P2. The plurality of jaws 4 are pushed by the wedge 3 to open at a maximum opening angle that is larger than the second opening angle (ST08). Next, the controller 9 drives the motor 20 in the reverse direction. The wedge 3 moves rearward by 12 mm from the end position P2 to the initial position P1 owing to the moving mechanism 25. The plurality of jaws 4 close from the maximum opening angle to the closed position. At the same time, the plurality of jaws 4 rotate around the screw shaft axis line K owing to the rotation mechanism 30 (ST09). The plurality of jaws 4 rotate, for example, by 45 degrees counterclockwise viewed from the front. The controller 9 stops the motor 20 and a series of the expansion operation is completed. The controller 9 determines the first advance position and the second advance position based on the signals transmitted from the initial position sensor 29a and the rotation number detection sensor 20d.

Each of the above-described steps (ST01-ST09) is performed while the user pulls the trigger 6. In more detail, when the user stops pulling the trigger 6, the switch 6a stops transmitting the on-signal to the controller 9. The controller 9 drives the motor 20 in the reverse direction to move the wedge 3 to the initial position P1. When the controller 9 determines that the wedge 3 moves to the initial position P1 based on a signal transmitted from the initial position sensor 29a, the controller 9 stops driving the motor 20. The plurality of jaws 4 close to the closed position. In this manner, even in a case when the user stops pulling the trigger 6 before a series of the expansion operation is completed, a position of the wedge 3 and an opening angle of the plurality of jaws 4 are returned to the initial condition and the motor 20 is stopped through the controller 9.

In the first embodiment, the end portion 60b of the tube 60 expands by varying a moving amount of the wedge 3 (a stroke amount of the wedge 3) so as to vary an opening angle of the plurality of jaws 4. In this case, an occurrence of the crack or the like of the end portion 60b of the tube 60 can be suppressed in comparison with a case where the end portion 60b of the tube 60 expands by a single expansion operation. When a tube expansion test was conducted using a portion of an annealed copper tube, an outer diameter of which is ⅜ inch and a thickness of which is 0.8 mm, the end portion of the copper tube was cracked. Further, when another tube expansion test was conducted using a portion of a processed/hardened copper tube, an outer diameter of which is 1 inch and a thickness of which is 1.5 mm, the end portion of the copper tube was also cracked. As shown in the above first embodiment, a stroke amount of the wedge 3 is varied three times to expand the end portion 60a of the tube 60, thereby suppressing the occurrence of a crack or the like.

Furthermore, in the first embodiment, a stroke amount of the wedge 3 is varied three times to expand the end portion 60a of the tube 60, thereby reducing an output power of the motor 20. The end portion 60b of the tube 60 expands owing to a resultant force of an output power of the motor 20 and inertia forces of the rotor 20c, the screw shaft 27, the wedge 3 etc. In a case where the end portion 60b of the tube 60 expands by a single expansion operation, a large inertia force is applied to the end portion 60b of the tube 60 after it starts to expand. However, the inertia force decreases as a finish of the expansion operation approaches. Accordingly, in a case where a large force is necessary to expand the end portion 60a of the tube 60, it is necessary to enlarge an output power of the motor 20 when the expansion movement is finished. Thus, a peak value of the current flowing through each of the electric components becomes large, which requires each of the electric components to endure a peak large current. On the contrary, in the first embodiment, a stroke amount of the wedge 3 is varied three times to expand the end portion 60a of the tube 60. In other words, an expansion start movement, in which a large inertia is generated, is conducted three times. Accordingly, an output power of the motor 20 can be reduced when each of the expansion movements is finished. Thus, a peak value of the current flowing through each of the electric components can be restricted.

Next, referring to FIGS. 9, 10, 15 and 17, a second embodiment of movements of the wedge 3 and the plurality of jaws 4 will be explained below. In the second embodiment, ST01 to ST06 are performed in the same manner as in the first embodiment. After ST06 is finished, the controller 9 drives the motor 20 in the reverse direction. The wedge 3 moves rearward by 4 mm from the second advance position to a first retreat position in front of the initial position owing to the moving mechanism 25. The plurality of jaws 4 close from the second opening angle to an opening angle that is smaller than the second opening angle and larger than a closing angle (zero degree). At the same time, the plurality of jaws 4 rotate around the screw shaft axis line K owing to the rotation mechanism 30 (ST11). At this point, an opening angle of the plurality of jaws 4 is approximately the same as the first opening angle. The plurality of jaws 4 rotate, for example, by 15 degrees counterclockwise viewed from the front.

Next, the controller 9 drives the motor 20 in the forward direction. The wedge 3 moves forward from the first retreat position to the end position P2 by 8 mm owing to the moving mechanism 25. The plurality of jaws 4 are pushed by the wedge 3 to open at the maximum opening angle (ST12). Then, the controller 9 drives the motor 20 in the reverse direction. The wedge 3 moves rearward from the end position P2 to the initial position P1 by 12 mm owing to the moving mechanism 25. The plurality of jaws 4 close from the maximum opening angle to the closed position. At the same time, the plurality of jaws 4 rotate around the screw shaft axis line K owing to the rotation mechanism 30 (ST13). The plurality of jaws 4 rotate, for example by 45 degrees counterclockwise viewed from the front. The controller 9 stops the motor 20 and a series of the expansion operation is completed. In the second embodiment, a total moving distance of the wedge 3 is shorter than in the first embodiment by a distance of two times between the initial position P1 and the first retreat position. The controller 9 determines the first advance position, the second advance position and the first retreat position based on the signals transmitted from the initial position sensor 29a and the rotation number detection sensor 20d.

Each of the above-described steps (ST01-ST06, ST11-ST13) is performed while the user pulls the trigger 6. For example, when the user stops pulling the trigger 6, the controller 9 stops the motor 20 after the wedge 3 is returned to the initial position P1 and the plurality of jaws 4 are closed to the closed position in the same manner as in the first embodiment.

Next, referring to FIGS. 9, 10, 15 and 18, a third embodiment of movement of the wedge 3 and the plurality of jaws 4 will be explained below. In the third embodiment, ST01 to ST08 are performed in the same manner as in the first embodiment. After ST08 is finished, the controller 9 drives the motor 20 in the reverse direction. The wedge 3 moves rearward by 12 mm from the end position P2 to the initial position P1 owing to the moving mechanism 25. The plurality of jaws 4 close from the maximum opening angle to the closed position. At the same time, the plurality of jaws 4 rotate around the screw shaft axis line K owing to the rotation mechanism 30 (ST21). The plurality of jaws 4 rotate, for example, by 45 degrees counterclockwise viewed from the front.

After ST21 is finished, the controller 9 determines whether the trigger 6 remains to be pulled, i.e., whether the controller 7 continues receiving the on-signal from the switch 6a (ST22). When the controller 9 receives the on-signal from the switch 6a, the controller 9 drives the motor 20 in the forward direction. The wedge 3 moves from the initial position P1 to the end position P2 by 12 mm owing to the moving mechanism 25. The plurality of jaws 4 are pushed by the wedge 3 to open at the maximum opening angle (ST23). After that, ST21 and ST22 are performed again. In this manner, the wedge 3 repeatedly moves in the forward direction and in the reverse direction between the initial position P1 and the end position P2. The plurality of jaws 4 repeatedly open and close between the closed position and the maximum opening angle. At the same time, the plurality of jaws 4 rotate around the screw shaft axis line K when closed. Owing to this leveling operation, the end portion 60b of the tube 60 can be expanded to form in an approximately tubular shape.

When the controller 9 stopes receiving the on-signal from the switch 6a in ST22, the controller stops driving the motor 20. A series of the expansion operation is completed in a state where the wedge 3 is returned to the initial position P1 and the plurality of jaws 4 are closed to the closed position. When the user stops pulling the trigger 6 during ST01 to ST08, the controller 9 stops the motor 20 after the wedge 3 is returned to the initial position P1 and the plurality of jaws 4 are closed to the closed position in the same manner as in the first embodiment.

As described above, the tube expansion tool for expanding the end portion 60b of the tube 60 includes the moving mechanism 25 that moves the wedge 3 in the front-rear direction as shown in FIGS. 9 and 10. The tube expansion tool 1 also includes the plurality of jaws 4 that mutually open radially outward when pushed by the wedge 3 moving forward. The tube expansion tool 1 includes the controller. The tube expansion tool 1 includes the switch 6a that transmits the on-signal to the controller 9 when the switch 6a is turned on. When the controller 9 receives the on-signal from the switch 6a, the controller 9 activates the moving mechanism 25 to move the wedge 3 to the first advance position in the forward direction to open the plurality of jaws 4 at the first opening angle. The moving mechanism 25 moves the wedge 3 in the reverse direction to close the plurality of jaws 4. The moving mechanism 25 moves the wedge 3 to the second advance position in the forward direction, which is positioned ahead of (and/or in front of) the first advance position, to cause the plurality of jaws 4 to open at the second opening angle, which is larger than the first opening angle. The moving mechanism 25 moves the wedge 3 in the reverse direction to close the plurality of jaws 4. In the present disclosures, the second advance position includes the end position to which the wedge 3 is movable.

Because of this configuration, when the switch 6a is turned on, the wedge 3 moves to the first advance position in the forward direction at first. The plurality of jaws 4 expand the end portion 60b of the tube 60 to the first opening angle. Next, the wedge 3 moves in the reverse direction to cause the plurality of jaws 4 to close. Then, the wedge 3 moves to the second advance position in the forward direction. The plurality of jaws 4 expand the end portion 60b of the tube 60 to the second opening angle which is larger than the first opening angle. In this manner, an opening angle of the plurality of jaws 3 can be changed by varying an advance position of the wedge 3. Accordingly, the end portion 60b of the tube 60 can be gradually expanded. By gradually expanding the end portion 60b of the tube 60, the end portion 60b of the tube 60 can be prevented from being damaged or cracked while it is expanded to a target diameter.

As shown in FIGS. 12 and 13, the tube expansion tool 1 includes the rotation mechanism 30 to rotate the plurality of jaws 4 around an axis of the wedge 3 in interlocking with the movement of the wedge 3 in the reverse direction. Because of this configuration, a position of each of the plurality of jaws 3 is varied around the axis of the wedge 3 each time the plurality of jaws 3 close (refer to FIG. 3). Accordingly, each of the plurality of jaws 3 that contacts the inner circumferential surface 60a of the end portion 60b of the tube 60 is varied around the axis of the wedge 3. Thus, an opening shape of the end portion 60b of the tube 60 can be an approximately circular by performing this expansion operation several times. Accordingly, the end portion 60b of the tube 60 can be expanded in an equal manner, thereby preventing the end portion 60b of the tube 60 from being damaged or cracked.

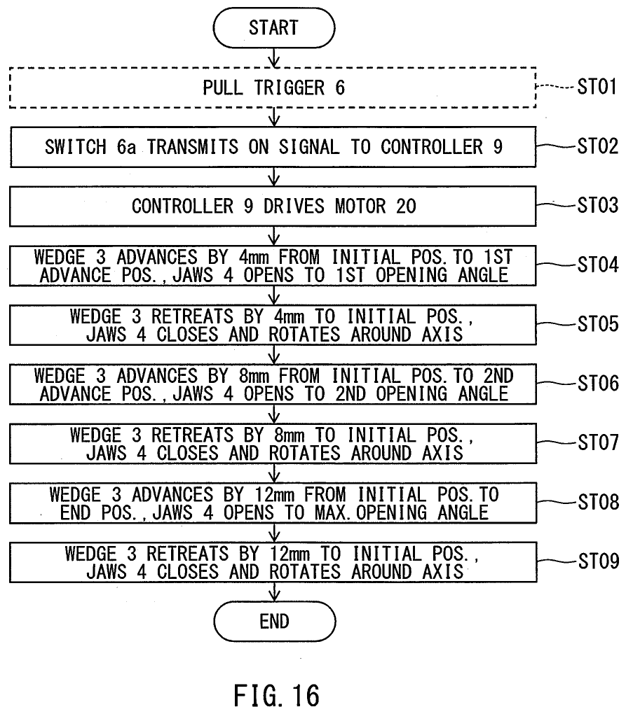

As shown in FIG. 16, when the controller 9 receives the on-signal from the switch 6a, the controller 9 drives the motor 20 to drive the moving mechanism 25 to move the wedge 3 in the forward direction from the initial position P1 to the first advance position. The wedge 3 then move in the reverse direction from the first advance position to the initial position to close the plurality of jaws 4. The controller 9 drives the motor 20 to drive the moving mechanism 25 to move the wedge 3 in the forward direction from the initial position P1 to the second advance position. The wedge 3 then moves in the reverse direction from the second advance position to the initial position P1. Because of this configuration, the plurality of jaws 4 completely close to the closed position each time the wedge 3 moves to the initial position in the reverse direction. Accordingly, when the plurality of jaws 4 close while rotating around the axis of the wedge 3, the plurality of jaws 4 are prevented from contacting the end portion 60b of the tube 60 (refer to FIG. 3). Thus, the plurality of jaws 4 can be prevented from clinging to the end portion 60b of the tube 60, thereby smoothly opening and closing the plurality of jaws 4.

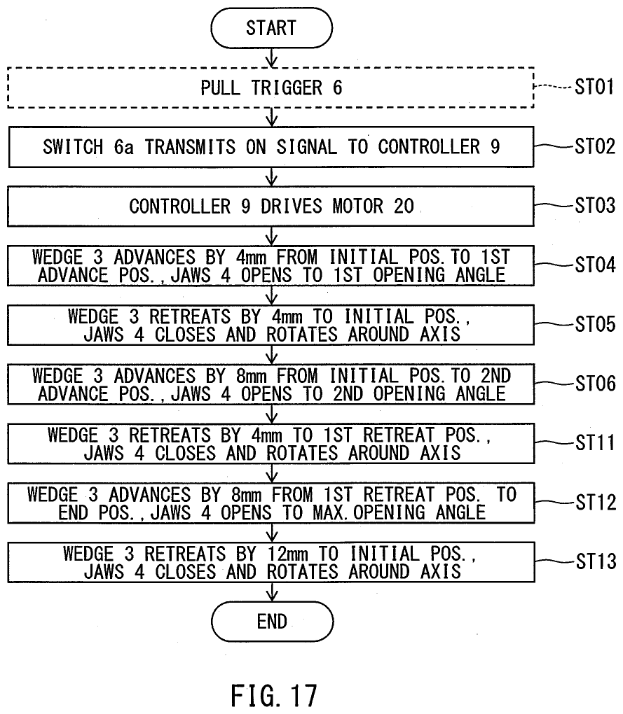

As shown in FIG. 17, the controller 9 drives the motor 20 to drive the moving mechanism 25 to move the wedge 3 in the forward direction from the initial position P1 to the second advance position. The wedge 3 then moves in the reverse direction from the second advance position to the first retreat position in front of the initial position. The controller 9 drives the motor 20 to drive the moving mechanism 25 to move the wedge 3 from the first retreat position to a position ahead of (and/or in front of) the second advance position. By positioning the first retreat position in front of the initial position P1, a total moving distance of the wedge 3 can be decreased. Accordingly, the end portion 60b of the tube 60 can be quickly expanded (refer to FIG. 3).

As shown in FIG. 16, while the controller 9 receives the on-signal from the switch 6a, the controller 9 moves the wedge 3 several times in the forward direction and in the reverse direction to bring the wedge 3 close to the end position P each time the wedge 3 moves forward. When the wedge 3 reaches the end position P2, the controller 9 moves (returns) the wedge 3 to the initial position P1 to stop moving the wedge 3. Because of this configuration, when the wedge 3 reaches the end position P2, the plurality of jaws 4 expand the end portion 60b of the tube 60 to the maximum opening angle (refer to FIG. 3). After an expansion operation of the end portion 60b of the tube 60 is completed, the wedge 3 moves (returns) to the initial position P1 and stops, thereby quickly transferring to a preparation of a next expansion operation for another tube. Accordingly, an operation time of expanding the end portion 60b of each of several tubes 60 can be shortened, thereby improving a workability of tube expansion work.

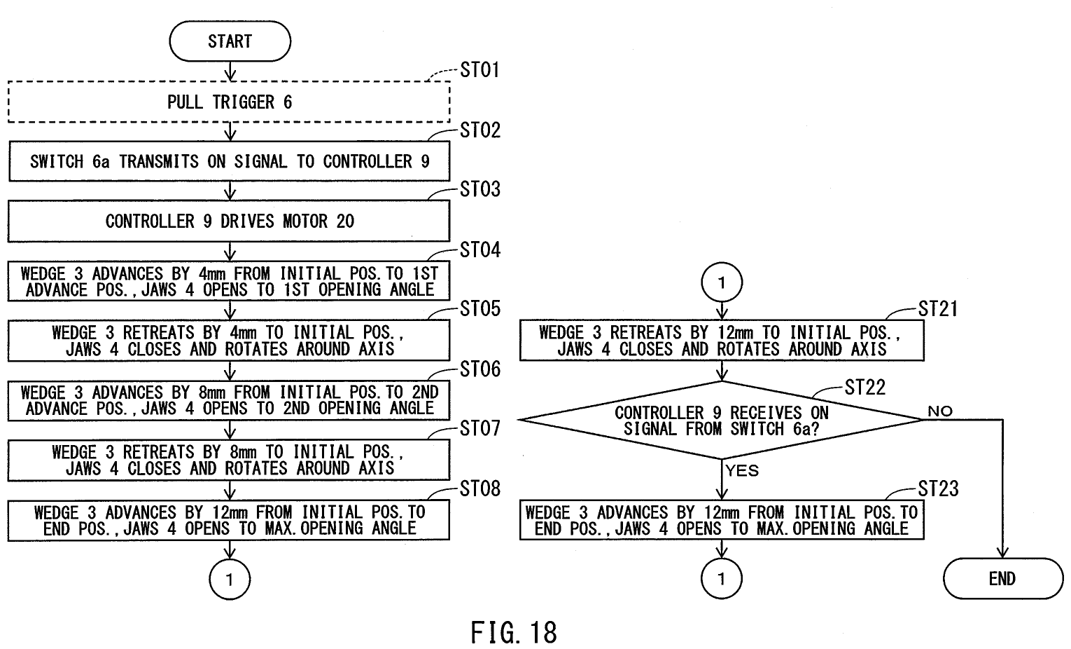

As shown in FIG. 18, while the controller 9 receives the on-signal from the switch 6a, the controller 9 moves the wedge 3 several times in the forward/reverse direction to bring the wedge 3 close to the end position P2 each time the wedge 3 moves forward. When the wedge 3 reaches the end position P2, the controller 9 moves the wedge 3 in the reverse direction. The controller 9 moves the wedge 3 in the forward direction to the end position P2 again. Because of this configuration, when the wedge 3 reaches the end position P2, the plurality of jaws 4 expand the end portion 60b of the tube 60 to the maximum opening angle. By repeating the operation of opening the plurality of jaws 4 to the maximum opening angle and closing the plurality of jaws 4, an opening shape of the end portion 60b of the tube 60 can be approximately circular.

As shown in FIG. 2, the tube expansion tool 1 includes the input part 18 to put a number of times the wedge 3 moves in the front-rear direction. The input part 18 is configured to transmit the information relating to the number of times to the controller 9. Accordingly, the number of times the wedge 3 moves in the front-rear direction can be changed according to a diameter, a thickness and a kind of material of the tube 60. Thus, the end portion 60b of the tube 60 can be efficiently prevented from being damaged or cracked.

As shown in FIGS. 15 and 16, the controller 9 determines the first advance position and the second advance position based on the information relating to the number of times that is input to the input part 18. Because of this configuration, the controller 9 efficiently moves the wedge 3 by determining the first advance position and the second advance position, thereby improving a workability of the tube expansion work.

As shown in FIG. 15, the tube expansion tool 1 includes the initial position sensor 29a that detects the initial position P1 of the wedge 3 (refer to FIG. 9) and transmits a signal to the controller 9. Also, the tube expansion tool 1 includes the end position sensor 29b that detects the end position P2 of the wedge 3 (refer to FIG. 10) and transmits a signal to the controller 9. The tube expansion tool 1 includes the motor 20 that drives the moving mechanism 25. The tube expansion tool 1 includes the rotation number detection sensor 20d that detects a rotation number of the motor 20 and transmits a signal to the controller 9. The controller 9 determines a position of the wedge 3 based on the signal from the rotation number detection sensor 20d. Because of this configuration, by detecting the rotation number of the motor 20, the controller 9 can quickly determine the position of the wedge 3 with respect to the initial position P1 and the end position P2. Accordingly, the wedge 3 can be moved and the plurality of jaws 4 can be opened/closed in a smooth manner.

As shown in FIGS. 9 and 10, the moving mechanism 25 includes the screw shaft 27 attached to the wedge 3. The moving mechanism 25 includes the female screw member 26 that engages the screw shaft 27 and rotates around the axis of the screw shaft 27 to move the screw shaft 27 in the front-rear direction. Because of this configuration, in the tube expansion tool 1, where rotation of the female screw member 26 is converted into the movement of the wedge 3 in the front-rear direction, the wedge 3 can be moved to several advance positions to open the plurality of jaws 4 at several opening angles. Thus, the end portion 60b of the tube 60 can be expanded while it can be prevented from being damaged or cracked.

The tube expansion tool 1 of the present embodiments discussed above may be modified in various ways. In the above-exemplified embodiments, the tube expansion tool 1 includes six jaws 4. Instead, the tube expansion tool 1 may include less than six jaws 4 or more than six jaws 4. Another kind of plurality of jaws having a closed diameter D1, a maximum diameter D2, a length in the front-rear diameter which differ from the present embodiments can be replaceably attached to the tool main body 10 together with the cap 2, based on an outer diameter, a thickness and a kind of material of the end portion 60b of the tube 60 to be expanded. Further, the tube 60 may not be limited to copper tubes. The tube 60 may be another kind of metallic tubes or tubes made of synthetic resin such as PEX tubes.

In the exemplified embodiments, the plurality of jaws 4 rotate counterclockwise when viewed from the front in the rotation mechanism 30. Instead, the jaw rotation mechanism 30 may be configured such that the plurality of jaws 4 rotate clockwise when viewed from the front. In this case, a rotation direction of the front shaft 32 in which the one-way clutch 42 transmits rotation power to the driving side gear 43 is a counterclockwise direction when viewed from the front (the first rotation direction R1 shown in FIG. 6).

In the exemplified embodiments, the moving mechanism 25 includes the plurality of balls 27b placed between the male screws 27a of the screw shaft 27 and the female screw 26b of the female screw member 26. Instead, the moving mechanism 25 may be a feed screw mechanism in which the male screw 27 and the female screw 26b are trapezoidal screws such that the male screw 27 directly engages the female screw 26b without placing the plurality of balls 27b. Further, instead of the moving mechanism 25, for example, a cam mechanism, in which cams rotate owing to an output power of the motor 20, can be used to move the wedge 3 in the front-rear direction. In this case, a movement of the wedge 3 in the front-rear direction can be gradually varied by switching a rotation direction of the cams of the cam mechanism between forward and reverse directions. Further, instead of the moving mechanism 25, for example, a hydraulic mechanism can be used to move the wedge 3 in the front-rear direction.

In the first and second exemplified embodiments, the end portion 60b of the tube 60 expands by moving the wedge 3 in the front-rear direction three time. Instead, the end portion 60b of the tube 60 may be expanded, for example, by moving the wedge 3 in the front-rear direction twice or more than three times. Positions to which the wedge 3 moves in the front-rear direction may be modified without limiting to the positions shown in the exemplified first to third embodiment. For example, after the wedge 3 moves to the first advance position twice or more than twice, the wedge 3 may move to the second advance position. For example, after the wedge 3 moves to the second advance position twice or more than twice, the wedge 3 may move a third advance position ahead of (and/or in front of) the second advance position. For example, the first retreat position may be in front of or behind the first advance position. For example, adding to the rearward movement of the wedge 3 to the first retreat position, the wedge 3 may move a second retreat position ahead of (and/or in front of) the first retreat position.

In the exemplified embodiments, the first advance position, the second advance position and the end position P2 are respectively positioned to be 4 mm, 8 mm and 12 mm in the forward direction from the initial position P1 in a proportional manner. Instead, a distance from the initial position P1 to each of the positions may be modified without limiting to the distances according to the above-described proportional positions or according to a linear function. For example, a distance from the initial position P1 to the first advance position, the second advance position and the end position P2 may be 6 mm, 9 mm and 12 mm, or 8 mm, 10 mm and 12 mm, or 5 mm, 10 mm and 12 mm, respectively. Further, a leveling operation as shown in the third embodiment may be added to the expansion operation of the second embodiment.

In the exemplified embodiments, the wedge 3 moves in the front-rear direction to open/closes the plurality of jaws 4 through continuous pulling operation of the trigger 6. Instead, the tube expansion tool 1 may be configured such that the tube expansion operation continues even if the pulling operation of the trigger 6 is stopped immediately. In this case, once the trigger 6 is pulled and the switch 6a transmits an on signal to the controller 9, the controller 9 continues driving the motor 20 until the wedge 3 completes to move in the front-rear direction at a specified number of times completely. Stopping of the pulling operation of the trigger 6 may not cause the tube expansion tool 1 to immediately become an off state without a case, for example, another off-operation such as an emergency stop operation and the like.

In the exemplified embodiments, the trigger 6 is pulled to turn on the switch 6a for activating the tube expansion tool 1. Instead, a push button and the like may be used to turn on the switch 6a without limiting to the trigger 6 for activating the tube expansion tool 1.

We claim:

1. A tube expansion tool for expanding an end portion of a tube, comprising:
a moving mechanism configured to move a wedge in a front-rear direction;
a plurality of jaws configured to mutually open radially outward when pushed by the wedge moving forward;
a controller; and
a switch configured to transmit an on-signal to the controller when the switch is turned on,
wherein when the controller receives the on-signal from the switch, the controller activates the moving mechanism to move the wedge
(i) forward to a first advance position to open the plurality of jaws at a first opening angle,
(ii) rearward to close the plurality of jaws,
(iii) forward to a second advance position ahead of the first advance position to open the plurality of jaws at a second opening angle that is larger than the first opening angle, and
(iv) rearward to close the plurality of jaws.

2. The tube expansion tool according to claim 1, further comprising a rotation mechanism that is configured to rotate the plurality of jaws around an axis of the wedge in interlocking with a rearward movement of the wedge.

3. The tube expansion tool according to claim 1, wherein the controller activates the moving mechanism to move the wedge
(i) forward from an initial position to the first advance position,
(ii) rearward from the first advance position to the initial position to close the plurality of jaws,
(iii) forward from the initial position to the second advance position, and
(iv) rearward from the second advance position to the initial position to close the plurality of jaws.

4. The tube expansion tool according to claim 1, wherein the controller is configured to activate the moving mechanism to move the wedge
(i) forward from an initial position to the first advance position,
(ii) rearward from the first advance position to the initial position to close the plurality of jaws,
(iii) forward from the initial position to the second advance position,
(iv) rearward from the second advance position to a first retreat position in front of the initial position, and
(v) forward from first retreat position to a position ahead of the second advance position.

5. The tube expansion tool according to claim 1, wherein while the controller receives the on-signal from the switch, the controller activates the moving mechanism to
(a) move the wedge several times in the front-rear direction and bring the wedge close to an end position each time the wedge moves forward, and
(b) move the wedge rearward to the initial position when the wedge reaches the end position and stop moving the wedge.

6. The tube expansion tool according to claim 1, wherein while the controller receives the on-signal from the switch, the controller activates the moving mechanism to
(a) move the wedge several times in the front-rear direction and bring the wedge close to an end position each time the wedge moves forward,
(b) move the wedge rearward when the wedge reaches the end position, and
(c) move the wedge forward to the end position again.

7. The tube expansion tool according to claim 1, further comprising an input part to put a number of times the wedge moves in the front-rear direction,
wherein the input part is configured to transmit an information relating to the number of times to the controller.

8. The tube expansion tool according to claim 7, wherein the controller determines the first advance position and the second advance position based on the information relating to the number of times.

9. The tube expansion tool according to claim 1, further comprising:
an initial position sensor configured to detect an initial position of the wedge and transmits a first signal to the controller;
an end position sensor configured to detect an end position of the wedge and transmits a second signal to the controller;
a motor configured to drive the moving mechanism; and
a rotation number detection sensor configured to detect a rotation number of the motor and transmits a third signal to the controller,
wherein the controller determines a position of the wedge based on the third signal from the rotation number detection sensor.

10. The tube expansion tool according to of claim 1, wherein the moving mechanism includes:
a screw shaft attached to the wedge; and
a female screw member that engages the screw shaft and rotates around an axis of the screw shaft to move the screw shaft in the front-rear direction.

11. The tube expansion tool according to claim 6, wherein when the controller stops receiving the on-signal from the switch during a movement of the wedge, the controller moves the wedge rearward to an initial position before the controller stops moving the wedge.

12. A tube expansion tool for expanding an end portion of a tube, comprising:
a female screw being rotated by a motor;
a screw shaft configured to engage the female screw to move the screw shaft in a front-rear direction;
a plurality of jaws configured to expand in a radial direction;
a wedge positioned at a front end of the screw shaft to insert into between the plurality of jaws, the wedge configured to expand the end portion of the tube via the plurality of jaws;
a moving mechanism configured to move the wedge in the front-rear direction;
a controller; and
a switch configured to transmit an on-signal to the controller when the switch is turned on,
wherein when the controller receives the on-signal from the switch, the controller activates the moving mechanism to move the wedge,
(i) forward from an initial position to a first advance position to open the plurality of jaws at a first opening angle;
(ii) rearward from the first advance position to the initial position to close the plurality of jaws;
(iii) forward from the initial position to a second position ahead of the first advance position to open the plurality of jaws at a second opening angle that is larger than the first opening angle; and
(iv) rearward from the second advance position to the initial position to close the plurality of jaws;
(v) forward from the initial position to an end position to open the plurality of jaws at a maximum opening angle; and
(vi) rearward from the end position to the initial position to close the plurality of jaws.

13. The tube expansion tool according to claim 12, wherein the controller is configured to repeat (v) and (vi) while the controller receives the on-signal from the switch.

14. The tube expansion tool according to claim 13, wherein when the controller stops receiving the on-signal from the switch during an execution of (v) and (vi), the controller completes (v) and (vi) before the controller deactivates the moving mechanism to stop moving the wedge.

15. The tube expansion tool according to claim 12, further comprising:
an initial position sensor configured to detect an initial position of the wedge and transmits a first signal to the controller;
an end position sensor configured to detect an end position of the wedge and transmits a second signal to the controller; and
a rotation number detection sensor configured to detect a rotation number of the motor and transmits a third signal to the controller,
wherein the controller determines a position of the wedge based on the third signal from the rotation number detection sensor.

16. The tube expansion tool according to claim 12, wherein the first advance position and the second advance position are arranged at approximately equal intervals between the initial position and the end position.

17. The tube expansion tool according to claim 12, wherein the first advance position and the second advance position are arranged at unequal intervals between the initial position and the end position.

18. A tube expansion tool for expanding an end portion of a tube, comprising:
a female screw being rotated by a motor;
a screw shaft configured to engage the female screw to move the screw shaft in a front-rear direction;
a plurality of jaws configured to expand in a radial direction;
a wedge positioned at a front end of the screw shaft to insert into between the plurality of jaws, the wedge configured to expand the end portion of the tube via the plurality of jaws;
a moving mechanism configured to move the wedge in the front-rear direction;
a controller; and
a switch configured to transmit an on-signal to the controller when the switch is turned on,
wherein when the controller receives the on-signal from the switch, the controller activates the moving mechanism to move the wedge
(i) forward from an initial position to a first advance position to open the plurality of jaws at a first opening angle,
(ii) rearward from the first advance position to the initial position to close the plurality of jaws,
(iii) forward from the initial position to a second position ahead of the first advance position to open the plurality of jaws at a second opening angle that is larger than the first opening angle,
(iv) rearward from the second advance position to a first retreat position in front of the initial position;
(v) forward from the first retreat position to an end position to open the plurality of jaws at a maximum opening angle, and
(vi) rearward from the end position to the initial position to close the plurality of jaws.

19. The tube expansion tool according to claim 18, wherein the controller repeats (v) and (vi) while the controller receives on-signal from the switch.

20. The tube expansion tool according to claim 19, wherein when the controller stops receiving the on-signal from the switch during an execution of (v) and (vi), the controller completes (v) and (vi) before the controller deactivates the moving mechanism to stop moving the wedge.
